(19) United States
(12) Patent Application Publication
(10) Pub. No.: US 2014/0342065 A1
(43) Pub. Date: Nov. 20, 2014

(54) PROCESS OF FOOD PRESERVATION WITH HYDROGEN SULFIDE

(71) Applicant: Siamak TABIBZADEH, (US)

(72) Inventors: Siamak Tabibzadeh, Newport Coast, CA (US); Hua Zhang, Hefei (CN); Jun Wu, Nanjing (CN); Jun Tang, Xuzhou (CN); Yongsheng Liu, Hefei (CN); Zhaojun Wei, Hefei (CN); Jian Liu, Hefei (CN); Huili Wang, Hefei (CN); Lanying Hu, Hefei (CN); Jianping Luo, Hefei (CN); Qian Wang, Hefei (CN)

(21) Appl. No.: 14/371,668

(22) PCT Filed: Jan. 7, 2013
(86) PCT No.: PCT/US2013/020520

§ 371 Date: Jul. 10, 2014

(30) Foreign Application Priority Data
Jan. 10, 2012 (CN) 201210006207.0

(51) Int. Cl. A23L 3/3409

(52) U.S. Cl. CPC A23L 3/3409; A23V 2002/00
USPC 426/319

(57) ABSTRACT

Food spoilage leads to food wastage, human morbidity and mortality. This food preservation takes advantage of use of Hydrogen Sulfide without or with Hydrogen or Helium into an environment where food is stored. The method delays food ripening, food spoilage, food decay and is safe, and preserves the natural characteristics of food, including color, flavor, aroma and texture. Hydrogen Sulfide treatment maintains higher activities of catalase, guaiacol peroxidase, ascorbate peroxidase, glutathione reductase and lower activities of lipoxygenase relative to un-treated controls. Hydrogen Sulfide also reduces malondialdehyde, Hydrogen peroxide, and superoxide anion to levels below those in control fruits during storage. Hydrogen and Helium are administered as gas and Hydrogen Sulfide is administered as a gas, liquid, or a Hydrogen Sulfide donor, within a closed environment or by providing Hydrogen Sulfide within the item. This also includes enhancement of innate endogenous Hydrogen Sulfide-Hydrogen production in the organisms including plants.

### CROSS REFERENCE TO RELATED APPLICATIONS

This application is a continuation-in-part of Chinese patent application Ser. No. CN20120006207.0, filed on Jan. 10, 2012 the entire contents of which is hereby expressly incorporated by reference herein.

### TECHNICAL FIELD

This invention involves a new usage of a known chemical compound. That is new usage of Hydrogen Sulfide gas for preservation of the freshness of vegetables, fruits, and foods including bread, meat, salmon, poultry, etc.

### BACKGROUND ART

### Background of the Invention

Crop and Post-Harvest Food Loss

Both quantitative and qualitative food losses occur from harvesting, to handling, storage, processing and marketing, to the final delivery of the products to the consumer. The latest published values indicate that, each year, industrialized and developing countries dispose of roughly similar quantities of food. In developed countries, the losses occur at the retailer and consumer levels. However, because of poor infrastructure, low levels of technology, and low investment in food production systems in the developing countries, the losses occur during the production, harvest, post-harvest and processing phases. The post-harvest losses of fruits and vegetables in the developing countries account for almost 50% of the produce.

The average rate of loss for individual fresh fruit, vegetable, meat, and poultry commodities at the supermarket level, as estimated by the Perishables Group, Inc., in the years 2005-2006 varied from 0.6 percent for sweet corn to 63.6 percent for mustard greens. The study showed that the impact on per capita estimates varied broadly among various commodities. Annual supermarket losses in 2006 were 8.4 to 51 percent for fresh fruit and averaged 11.4 percent for fresh fruit, 9.7 percent for fresh vegetables, and 4.5 percent for fresh meat, poultry, and seafood.

Food and Agricultural Organization (FAO) of the United Nations estimates that 25 to 35 percent of world food production is lost through natural causes such as pests, microbes, and insects. In the ASEAN countries alone, post-harvest losses of cereals are estimated at 30 percent, fruits and vegetables at 20 to 40 percent, and up to 50 percent for fish. Some products in Africa suffer post-harvest losses as high as 50 percent. One of the best responses to the problem of the world hunger is preservation of what has already been grown. If post-harvest losses worldwide could be minimized, food supply gains could be made without allocation of additional resources.

The softening that accompanies ripening enhances fruit damage during shipping and handling processes. This softening plays a major role in determining the cost factor, because it has a direct impact on palatability, consumer acceptability, shelf life, and post-harvest disease/pathogen resistance. Generally, reduction in fruit firmness due to softening is accompanied by increased expression of cell wall-degrading enzymes.

Each year, a large amount of crops are lost due to attacks by pest and parasites such as Synchytrium endobioticum, Ceratostomella ulmi, Phytophthora infestans, Puccinia graminis, Pseudotsuga taxifolia Pseudotsuga menziesii], Phaeocryptopus gaeumanni, Actinomyces scabies Streptomyces scabiei, Puccinia glumarum Puccinia striiformis, Ustilago spp., Fusarium spp., Ophiobolus graminis Gaeumannomyces graminis, Leptosphaeria herpotrichoides, Claviceps purpurea. For this reason, farmers use a variety of pesticides, substances or mixture of substances that intend to prevent, destroy, repel or mitigate pests and growth of micro-organisms on crops. Pesticides include herbicides that destroy weeds and other unwanted vegetation, insecticides that control a wide variety of insects, fungicides that prevent the growth of molds and mildew, disinfectants that prevent the spread of bacteria, and chemicals that control mice and rats. Due to such a widespread use of chemicals in food protection, people consume residues of pesticides which are left on or within food. There is as yet no clear understanding of the health effects of these pesticide residues. Results from ongoing studies on pesticide exposures show that farmers who use agricultural insecticides experience an increase frequency of headaches, fatigue, insomnia, dizziness, hand tremors, and other neurological symptoms. Pesticide exposure causes from simple irritation of the skin and eyes to more severe effects such as those that affect the nervous system, those that cause reproductive problems, and also cancer. There is a positive association between pesticide exposure and development of non-Hodgkin's lymphoma and leukemia as well as neurological problems, birth defects, fetal death and neuro-developmental disorder.

The problems of food production, processing and storage, therefore, require a continuing search for effective, and technically and economically feasible alternative methods of food preservation.

Food Spoilage

Spoilage is a process of food deterioration that reduces the edibility of food. Ultimately, food that is partially or completely spoiled is often totally un-edible. Food that is capable of such spoilage is referred to as “perishable.” Degradation, loss of color and flavor dissipation of freshly cut plant parts are known to be caused by the occurrence of oxidation, enzymes, microbes, and metal ions. Autolysis, the process that is largely responsible for the change of color, texture, and flavor of food over time, occurs because of naturally occurring enzymes in all plants and animals. Atmospheric oxygen can also react with some food components which can increase the level of rancidity or change in color of food. Finally, infestations (invasions) by insects and rodents account for huge losses in food stocks.

Among other causes that spoil food; the growth of micro-organisms—including bacteria and yeast (mold)—on food products is the primary cause of food spoilage. Some of these bacteria such as E. coli or Salmonella directly threaten human health. Foods with a high sugar content are susceptible to growth of yeast. Micro-organisms including bacteria and yeast break down food and produce by-products such as acids that make food less edible. As such, affected foods will acquire a change in taste, texture, aroma, and color. Spoiled, un-cooked, or under-cooked animal flesh is typically quite toxic, and its consumption can result in serious illness or death. The toxic effect that results from the consumption of spoiled food is known as “food poisoning” or “food borne illness.”

Softening, and discoloration are common changes that accompany ripening and then senescence of fruits. The ripening and senescence of post-harvest fruits is a complex and highly regulated process that involves lipid peroxidation, resulting in the loss of integrity of the plasma membrane. Endogenous signaling molecules and hormones which are also involved, include ethylene, ABA, auxin, IP3, Ca²⁺, H₂O₂, and NO. An in-evitable result of mitochondrial, chloroplast and plasma membrane-linked electron transport is production of reactive oxygen species (ROS) including H₂O₂. These species cause damage by oxidizing various macromolecules in both plants and mammalian cells. This reactive nature of ROS, therefore, makes them harmful to all cellular components. ROS overproduction and oxidative damage is a universal event in post-harvest fruits during their storage and contributes to food spoilage. Thus, it follows that inhibition of these oxidative damages can prolong post-harvest shelf life of fruits.

Food decay is a process that includes putrefaction, fermentation and rancidity. Putrefaction is one of seven stages in the decomposition of the body of a dead animal. Fermentation is a metabolic process whereby electrons released from nutrients are ultimately transferred to molecules obtained from the breakdown of the same nutrients. Rancidification results from chemical decomposition of fats, oils and other lipids. There are three types of rancidity: ester hydrolytic, oxidative and microbial. Hydrolytic rancidity occurs when water splits fatty acid chains away from the glycerol backbone in triglycerides (fats). Because most fatty acids are odorless and tasteless, this process will usually go unnoticed. However, when the triglyceride is derived from short chain fatty acids, the released carboxylic acid can confer strong flavors and odors; this can be observed in butter, which has a high content of butyric acid derivatives. Oxidative rancidity is associated primarily with the degradation of un-saturated fat by oxygen. During this process, the double bonds of an un-saturated fatty acid undergo cleavage, releasing volatile aldehydes and ketones. This process can be suppressed by the exclusion of oxygen or by the addition of antioxidants. Microbial rancidity refers to a process by which lipases in the micro-organisms break down fat. This pathway is currently prevented by sterilization. Generally, food decay, as a result of these processes, leads to undesirable odors and flavors. In processed meats, these flavors are collectively known as warmed over-flavor. Rancidification reduces the nutritional value of the food. Some vitamins are highly sensitive to such degradation processes.

Preservation of Food

The preservation of food has been a principal concern of mankind since the dawn of civilization. During early civilization, food preservation processes developed slowly and were mainly limited to smoking or curing with salt. With the advent of the industrial revolution and the discovery that food spoilage was due to the activity of living organisms such as bacteria, yeast or molds, the art of preserving food developed rapidly. Due to the health hazards that spoiled food poses, there is a great interest in preserving food and preventing its spoilage. A number of methods have been devised that prevent or slow down the process of food spoilage, including the use of techniques that expand the shelf-life of food and prolong the duration that food can be consumed. Acidulants are known to prevent microbial degradation by maintaining a relatively low pH environment, but their effectiveness is limited to temporary conservation.

Present day methodologies for preserving food include sterilization by heat, refrigeration, pickling and the addition of chemical preservatives, Ohmic heating and dielectric heating, which includes radio frequency (RF) and microwave (MW) heating as well as non-thermal processing. Among other methods are freezing, vacuum sealing (removes oxygen required for growth of micro-organisms), or drying which by removing water prevents the growth of micro-organisms. All these techniques allow for a longer term food storage.

Sterilization by heat is useful since it provides complete destruction of all bacterial life forms. However, heat sterilization is not well-suited for treating heat sensitive food stuffs such as vegetables or fruits. Furthermore, heat sterilization does not prevent subsequent attacks by bacteria. Preservation of food by refrigeration requires the continued operation of refrigeration systems. Drying of food by processes such as freeze-drying is an effective food preservation process; however, such drying techniques require specialized equipment and are not well suited for many types of foods. The use of chemical preservatives is also a popular food preservation technique; they can be added to many different types of food stuffs and do not require special processing equipment or continuous attention (as opposed to freeze-drying or refrigeration, which require energy, equipment and attention). The use of chemical preservatives, however, is undesirable since the chemical adulterants incorporated into the food may be harmful to the human body.

One process which has been widely used involves preserving food by storage in an atmosphere of gaseous ethanol. Although the storage of food in an ethanol vapor atmosphere has been found effective in preserving a wide variety of foods, further improvements are necessary with regards to preserving high moisture foods, such as fresh meat and fresh fish. In order to completely prevent the growth of micro-organisms in fresh meat and fish, a high concentration of ethanol vapors in the atmosphere surrounding the fish is necessary. As a result, the meat and fish become tainted with the odor of ethanol. Although the partial absorption of ethanol by the meat or fish is not a health hazard, it does produce a bad taste in the meat or fish.

Sulfiting agents including sulfur dioxide, sodium sulfite, sodium and potassium bisulfite and sodium and potassium metabisulfite when added to the food possess the ability to preserve vegetable food products. These products have been used particularly in the restaurant industry. Sulfites have also been employed as preservatives in prepared foods such as flavored beverages, syrup concentrates, wine and vinegar as well as in the processing of sugar, corn starch and shrimp. Sulfiting of fresh food such as whole peeled potatoes results only in a shelf life (at 8° C.) for up to ten days. Moreover, allergic reactions to these compounds and sometimes death have been reported. As a result of such occurrences, the U.S. Government Food and Drug Administration (FDA) has removed the use of sulfites on raw foods and vegetables as “generally recognized as safe” (GRAS) and has imposed labeling requirements for direct or indirect additions of sulfites on packaged food. As such, the use of sulfiting agents has fallen into disfavor.

Ohmic heating and dielectric heating, which includes radio frequency (RF) and microwave (MW) heating, are promising alternatives to conventional methods of heat processing. However, such technologies do not lend themselves to preservation of foods that cannot be heated prior to consumption. To avoid the deleterious effects of heat on flavor, color and nutritive value of foods, other methods are developed. Among these, the term ‘non-thermal processing’ is often used to designate technologies that are effective at ambient or sub-lethal temperatures. High hydrostatic pressure, pulsed electric fields, high-intensity ultrasound, ultraviolet light, pulsed light, ionizing radiation and oscillating magnetic fields have the ability to inactivate micro-organisms only to varying degrees. These novel technologies are still struggling with full industrial application. For example, irradiation has a high potential and is probably one of the most versatile among the food preservation technologies. However, its development and commercialization has been hampered because it leads to the development of radiolytic compound within the food and un-favorable public attitude towards their use. Pulsed Light is also considered an emerging, non-thermal technology capable of reducing the microbial population on the surface of foods and food contact materials by using short and intense pulses of light in the Ultraviolet Near Infrared (UV-NIR) range. Pulsed Light has a relatively low operation costs and does not significantly contribute negatively to the environmental impact of the processes where it is included because it has the potential to eliminate micro-organisms without the need for chemicals. The most extensively researched and promising non-thermal processes for preservation of foods appear to be pulsed electric fields (PEF) and high hydrostatic pressure (HHP) which are being commercially applied mostly for the processing of juices and other fruit-derived products by using pressure rather than heat to achieve pasteurization. PEF inactivates micro-organisms with minimal effects on the nutritional, flavor and functional characteristics of food products due to the absence of heat. PEF technology is based on the application of pulses of high voltage to the product which is placed between a pair of electrodes that confine the treatment gap of the PEF chamber. The large field intensities are achieved through storing a large amount of energy in a capacitor bank (a series of capacitors) from a direct current power supply, which is then discharged in the form of high voltage pulses. The pulse caused by the discharge of electrical energy from the capacitor is allowed to flow through the food material for an extremely short period of time (1-100 microseconds) and can be conducted at moderate temperatures for less than 1 second. When food is subjected to the electrical high-intensity pulses several events, such as resistance heating, electrolysis and disruption of cell membranes, occurs which all contribute to the inactivation of micro-organisms.

The photobiological effects of light, including visible light (380-780 nm), near ultraviolet light (300-380 nm) and far ultraviolet light (190-300 nm), have been studied for many years, for example, as reported in Jagger, J., “Introduction to Research in Ultraviolet Photobiology”, Prentice Hall, Inc., 1967, and efforts have been made to employ light to sterilize food products or containers for food products. U.S. Pat. No. 2,072,417 describes illuminating substances, e.g., milk, with active rays, such as UV rays. U.S. Pat. No. 3,817,703 describes sterilization of light-transmissive material using pulsed laser light. U.S. Pat. No. 3,941,670 describes a method of sterilizing materials, including foodstuffs, by exposing the material to laser illumination to inactivate micro-organisms. However, such methods have various deficiencies, such as limited throughput capacity, limited effectiveness, adverse food effects, in-efficient energy conversion (electrical to light) and economic disadvantages.

Among several food preservation methods, change of the gaseous composition in contact with the food to be preserved are the most common. Changing the gaseous composition in contact with the food to be preserved is necessary, since air and humidity cause yeast and other micro-organisms to grow on food, leading to a loss of flavor and aroma and changes in their color. A number of documents including WO 2008/094083, WO 2006/121540, WO2009100509A1, U.S. Pat. No. 4,971,821, U.S. Pat. No. 6,579,549, U.S. Pat. No. 2,064,678, U.S. Pat. No. 3,477,192, EP2138785 A2, describe change in gaseous compositions inside food packages. Among the gases being used are inert gases such as nitrogen, carbon dioxide, Hydrogen and argon. Such processes are applied in foods as alternatives to the expansion of the validity period and/or maintenance of the food quality throughout its validity period. However, these processes all entail multiple steps including heating, and other food processing steps, and require machinery and skilled personnel.

Thermal or non-thermal approaches used in the food industry, such as cooking, pasteurization, sterilization, drying, use of pulsed electrical fields, UV, ultrasound or other techniques, they all involve the consumption of a significant amount of diverse energy types that has markedly increased the footprint of the food industry. The preservation of liquid media by PEF was shown to cause operational costs that is about 10-fold higher than those needed for conventional thermal processing. Reduction of the use of non-renewable energy resources, lower emission of air pollutants such as CO₂, and increase of the energy efficiency of devices and processes utilizing renewable energy, is now a major concern for all processors. In addition, all these technologies require skilled use by professionals, are not applicable to all food categories, can not be applied during food transport or to storage of food within refrigerator and are not available for the consumer use. Clearly, methods and techniques that utilize low energy, and can be used during food transport and after purchase of the food by the consumer, will decrease food spoilage, increase food availability, lowers the cost of the food and decreases human morbidity and mortality from spoiled food.

What is needed in preserving food and prevention of growth of organisms is using a method that is cost effective and easy to carry out. The proposed “non-thermal process” of food preservation with combination of Hydrogen Sulfide with Hydrogen with or without Helium provides the solution.

### DISCLOSURE OF THE INVENTION

It is an object of a process of food preservation with Hydrogen Sulfide without or with Hydrogen and without or with Helium prevents food spoilage, increases shelf life of foods, and serves as a germicidal, insecticidal, fungicidal, rodenticidal, pediculicidal, and biocidal method. This is done by introduction of the Hydrogen Sulfide and Hydrogen, with or without Helium into the environment where food is stored. The method is non-thermal, delays food ripening, is safe, and preserves the natural characteristics of the processed food, including its color, flavor, aroma and texture.

It is an object of a process of food preservation with Hydrogen Sulfide without or with Hydrogen and without or with Helium for sustained significantly lower rot index, higher fruit firmness, and lower respiration intensity and polygalacturonase activities than un-treated and non-preserved controls. Hydrogen Sulfide treatment maintains higher activities of catalase, guaiacol peroxidase, ascorbate peroxidase, and glutathione reductase and lower activities of lipoxygenase relative to un-treated and non-preserved controls.

It is an object of a process of food preservation with Hydrogen Sulfide without or with Hydrogen and without or with Helium to maintain higher contents of reducing sugars, soluble proteins, free amino acid, and endogenous Hydrogen Sulfide in fruits. The method that we describe does not include food processing or special packaging, does not require removal of air from package or changing the composition of food, requires low energy and no special machinery or technical skill and can be used by commercial companies as well as by the end consumers.

It is an object of a process of food preservation with Hydrogen Sulfide without or with Hydrogen and without or with Helium to be administered as a gas, liquid, a Hydrogen Sulfide donor, within a closed environment where crop or food including fruits, produce, plants, meat, poultry, fish, water or any other item is placed or by providing the Hydrogen Sulfide and or Hydrogen within the item to be protected. This includes the enhancement of innate endogenous Hydrogen Sulfide and or Hydrogen production in the organisms including plants.

It is still another object of the process of food preservation with Hydrogen Sulfide without or with Hydrogen and without or with Helium to be applied depending on the item. Specific requirements as necessary for decontamination include the duration of Hydrogen Sulfide exposure (for the period of food preservation), temperature (ranging from 0-ambient), and the amount of Hydrogen Sulfide, Hydrogen and Helium gas within the closed environment which can vary from 1->1000 parts per million (ppm). Hydrogen is generated by a chemical reaction, or by introduction of Hydrogen from electrolysis of water or release of Hydrogen gas from Hydrogen scavengers to a closed environment where food including fruits, produce, plants, meat, poultry, fish, water or any other item is placed. This also includes the enhancement of innate endogenous Hydrogen production in the organisms including plants. Addition of Helium (1->1000 ppm) enhances the Hydrogen Sulfide-Hydrogen preservation further but is not required. Helium can be added as a gas or by any chemical reaction or method that provides adequate concentration of Helium within the environment.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWING(S)

FIG. 1 shows how photosynthetic bacteria utilize water and carbon dioxide to generate oxygen.

FIG. 2 shows Oxidative phosphorylation.

FIG. 3A shows a structure of Hydrogen Sulfide.

FIG. 3B shows a structure of H₂O.

FIG. 4 shows the conversion of polyphenol by phenol oxidase to quinone.

FIG. 5 shows Ethylene pathway.

FIG. 6 shows Hydrogen Sulfide Synthesis.

FIG. 7 shows the chemical structure of Sul-free.

FIGS. 8A and 8B show Hydrogen-mediated fruit preservation at room temperature.

FIG. 9 shows Hydrogen Sulfide-mediated-mediated inhibition of growth of micro-organisms at room temperature.

FIG. 10 shows Hydrogen Sulfide-mediated-mediated fruit preservation and inhibition of growth of micro-organisms at room temperature.

FIG. 11 shows Hydrogen Sulfide-mediated-mediated fruit preservation and inhibition of growth of micro-organisms at room temperature.

FIG. 12 shows Hydrogen Sulfide-mediated-mediated food preservation and inhibition of growth of micro-organisms at room temperature.

FIG. 13 shows Hydrogen Sulfide-mediated-mediated food preservation and inhibition of growth of micro-organisms at room temperature.

FIG. 14A shows the effect of Hydrogen Sulfide on post-harvest shelf life and rot index in strawberry fruits.

FIG. 14B shows a graph of exposure of strawberries to Hydrogen Sulfide donor, NaHS, between 0 and 1.25 mmol/L¹ for 0-4 days.

FIG. 15 shows graphs of Hydrogen Sulfide-mediated-mediated food preservation.

FIG. 16 shows graphs of Hydrogen Sulfide-mediated-mediated food preservation.

FIG. 17 shows graphs of Hydrogen Sulfide-mediated food preservation.

FIG. 18 shows graphs of Hydrogen Sulfide-mediated food preservation.

FIG. 19 shows Hydrogen Sulfide and Hydrogen-mediated fruit preservation at room temperature.

FIG. 20 shows, Hydrogen Sulfide, Hydrogen, Hydrogen Sulfide and Hydrogen and Helium-mediated fruit preservation at room temperature.

FIG. 21 shows graphs of the effect of Hydrogen, Hydrogen Sulfide, and Helium and their combination on firmness of strawberries stored at room temperature.

FIG. 22 shows a graph of the effect of Hydrogen, Hydrogen Sulfide, and Helium and their combination on change in surface color (L* value) of strawberries stored at room temperature.

FIG. 23 shows a table of inhibition of growth of bacterial and fungal colonies by NaHS, Hydrogen Sulfide water (0.04%), Hydrogen, and Helium gas during storage at room temperature.

FIG. 24 shows a table of assessment of consistency, color, aroma and taste and growth of bacteria and yeast in food stored at room temperature.

FIG. 25 shows a table of the effect of Hydrogen Sulfide on free amino acid content of strawberries during storage at 20° C.

FIG. 26 shows a table of concentration of Hydrogen Sulfide in fruits that were maintained at room temperature in presence of Hydrogen Sulfide water (0.04%).

### BEST MODE FOR CARRYING OUT THE INVENTION

Perspective on metabolism and energy production in living organisms; Hydrogen, oxygen, and Hydrogen sulfide.

All living organisms are required to make energy for the synthesis of structural molecules, housekeeping of their molecular machinery, repair of damaged molecules, movement, growth and other cell functions. However, the method by which energy is produced is vastly different among organisms that live either on the surface of the earth, within oceans or deep within the crust of the earth mantle.

Hydrogen

Hydrogen is an element with the chemical formula H which is comprised of one proton and one electron. Hydrogen is the lightest and first gas in the periodic table and is a colorless, odorless, tasteless, non-toxic, non-metallic gas which is naturally present as a diatomic gas with the molecular formula H₂. Hydrogen is the most abundant chemical substance, constituting roughly 75% of the Universe's baryonic mass. However, because of its light weight, which enables it to escape from the gravity of the Earth more readily than other heavier gases, Hydrogen gas is present only in minute quantities in the Earth's atmosphere (1 ppm by volume). Hydrogen gas is generated in some organisms by the transfer of reducing equivalents produced during pyruvate fermentation to water. H₂ is also produced by other micro-organisms from some forms of anaerobic metabolism and usually via reactions which are catalyzed either by iron- or nickel-containing enzymes called Hydrogenases. These enzymes catalyze the reversible redox reaction between H₂ and its components; two protons and two electrons. Some organisms, including the algae Chiamydomonas reinhardtii and cyanobacteria, have evolved mechanisms to generate Hydrogen in the dark reactions in which protons and electrons are reduced to form H₂ gas by specialized Hydrogenases in the chloroplast. While some organisms generate Hydrogen, some micro-ogranisms such as photo-synthetic bacteria utilize H₂ in the generation of energy as shown in below Hydrogenase

H₂+NADP⁺----------------->NADPH₂

Oxygen

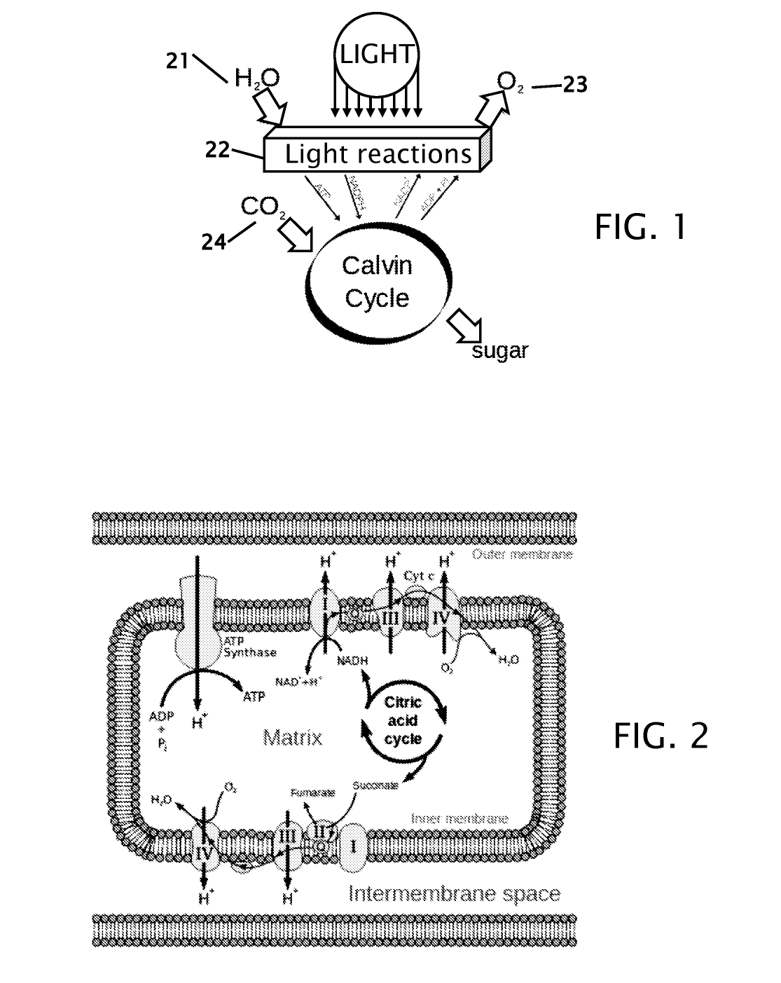

In contrast to Hydrogen, the earth atmosphere is comprised mainly of nitrogen and oxygen gases with only oxygen being used by most living organisms as a source of energy. Oxygen is a chemical element with symbol 0 and atomic number 8. In nature, free oxygen is produced by the light-driven splitting of water during oxygenic photosynthesis. Some estimate that the Green algae and cyanobacteria in marine environments provide about 45% to 70% of the free oxygen which is present in the Earth's atmosphere. The rest of the oxygen in the atmosphere is produced by terrestrial plants. FIG. 1 shows how (CO₂) 24 with water 21 is decomposed to form oxygen 23 in the light reactions (Calvin cycle) 22 in photo-synthetic organisms. A simplified formula for photosynthesis which generates both glucose and oxygen a is shown below.

6 carbon dioxide (CO₂)+6 Water (H₂O)+Sunlight(photon)→Glucose (C₆H₁₂O₆)+6 Oxygen (O₂)

Molecular dioxygen, O₂, produced and released into the atmosphere is essential for cellular respiration in most living aerobic organisms for generation of energy. In some organisms such as molluscs and some arthropods, hemocyanin and in spiders and lobsters, hemerythrin, is used for capturing oxygen from the earth atmosphere. In higher order organisms such as vertebrates, O₂ diffuses through membranes of alveolar epithelial cells in the lungs and enters red blood cells. Hemoglobin in these cells then binds O₂. Oxygen, then, reaches and diffuses into cells of multi-cellular organisms for generation of energy. For example, the photolytic oxygen evolution occurs in the thylakoid membranes of photo-synthetic organisms. The generation of energy adenosine tri-phosphate (ATP) occurs by a process of photo-phosphorylation that results in the formation of a proton gradient across the thylakoid membrane. The O₂ remaining after oxidation of the water molecule is released into the atmosphere. Oxygen is used in eukaryotes by structures called mitochondria, which remain from a primitive intra-cellular parasite, to help generate ATP during oxidative phosphorylation (FIG. 2). The reaction for aerobic respiration is essentially the reverse of photosynthesis and generates energy as shown by the following formula.

Glucose (C₆H₁₂O₆)+6 Oxygen (O₂)→6 carbon dioxide (CO₂)+6 Water (H₂O)+2880 kJ·mol⁻¹

Only anaerobic micro-organisms do not use oxygen and utilize other means for generation of their energy. One form of generation of energy, in the absence of oxygen, is called fermentation, a process of extracting energy from the oxidation of organic compounds, such as carbohydrates, using an endogenous electron acceptor, which is usually an organic compound. Eukaryotes also use this form of energy production under hypoxia, a process referred to as anaerobic glycolysis as shown in the following reaction:

Glucose (C₆H₁₂O₆)+2 adenosine diphosphate(ADP)+2 inorganic phosphate (Pᵢ)+2 Nicotinamide adenine dinucleotide,(NAD⁺)→2 pyruvate (CH₃COCOO⁻)+2 adenosine tri-phosphate(ATP)+2 NADH+2 water (H₂O)+2 Hydrogen (H⁺)

Hydrogen Sulfide

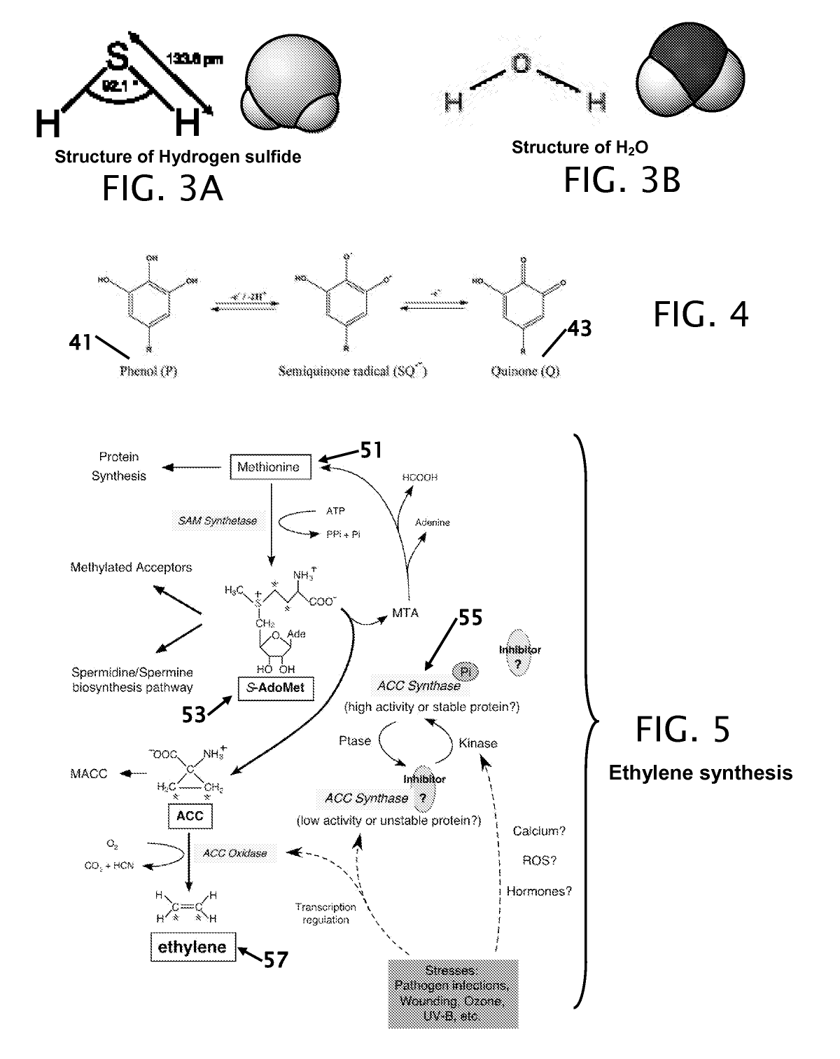

Before oxygen became rich on earth, early life forms had to utilize other means for generation of their energy and used one of the abundant element, the sulfur, in early earth some 3.5 billion years ago. Some of descendants of these forms of life still exist today on earth. These sulfur-reducing and sulfate-reducing bacteria derive their energy from oxidizing Hydrogen or organic molecules by reducing elemental sulfur or sulfate to Hydrogen sulfide. NADH is formed from sulfur or H₂S. FIG. 3A shows a structure of Hydrogen Sulfide which resembles the structure of water which is shown in FIG. 3B.

Hydrogen Sulfide (British English: Hydrogen sulphide) shown in FIG. 3A is a compound with the chemical formula H₂S. Hydrogen Sulfide is a colorless, toxic, flammable gas with a characteristic foul odor similar to that of rotten eggs. The term Hydrogen Sulfide or “H₂S” in this document refers mostly, but not solely, to combinations of the inorganic sulfides as un-dissociated Hydrogen Sulfide (H₂S), hydro-sulfide anion (HS⁻), and the sulfide anion (S²⁻) in water. Hydrogen Sulfide is slightly heavier than air. Hydrogen Sulfide and oxygen burn with a blue flame to form sulfur dioxide (SO₂) and water. Hydrogen Sulfide acts as a reducing agent. At high temperatures or in presence of catalysts, sulfur dioxide can be made to react with Hydrogen Sulfide to form elemental sulfur and water. This is exploited in the Claus process, the main way to convert Hydrogen Sulfide into elemental sulfur. Hydrogen Sulfide is slightly soluble in water and acts as a weak acid, giving the hydro-sulfide ion HS⁻ (pKa=6.9 in 0.01-0.1 mol/liter solutions at 18° C.) and the sulfide ion S²⁻ (pKa=11.96). A solution of Hydrogen Sulfide in water, known as sulfhydric acid or hydro-sulfuric acid, is initially clear but over time turns cloudy. This is due to the slow reaction of Hydrogen Sulfide with the oxygen dissolved in water, yielding elemental sulfur, which precipitates out of solution. Hydrogen Sulfide reacts with metal ions to form metal sulfides, which may be considered the salts of Hydrogen sulfide. Some ores are sulfides. Metal sulfides often have a dark color. Lead (II) acetate paper is used to detect Hydrogen Sulfide because it turns grey in the presence of the gas as lead (II) sulfide is produced.

Reacting metal sulfides with strong acid liberates Hydrogen sulfide. In nature, Hydrogen Sulfide is generated from anaerobic digestion by bacterial breakdown of organic matter in the absence of oxygen. Hydrogen Sulfide is also emitted in volcanic gases, and is present in natural gas. Hydrogen Sulfide exists in some well waters and ozone is often used for its removal. An alternative method uses a filter with manganese dioxide. Both methods oxidize sulfides to much less toxic sulfates.

In high concentrations, Hydrogen Sulfide is considered a broad-spectrum poison, affecting several different systems in the body, although the nervous system is by far more sensitive. The toxicity of high levels of Hydrogen Sulfide is comparable with that of Hydrogen cyanide. Hydrogen Sulfide forms a complex bond with iron in the mitochondrial cytochrome oxidase, preventing cellular respiration and generation of energy. Hydrogen Sulfide occurs naturally in the environment, as well as in plants and human body; the body contains enzymes that are capable of detoxifying Hydrogen Sulfide by its oxidation to a harmless sulfate. Hence, consumption of food containing low levels of Hydrogen Sulfide or exposure to minimal amounts of Hydrogen Sulfide in the environment prove that the gas may be tolerated. At some threshold level, believed to average around 300-350 ppm, the oxidative enzymes get overwhelmed. Treatment of Hydrogen Sulfide toxicity involves immediate inhalation of amyl nitrite, injections of sodium nitrite, inhalation of pure oxygen, administration of bronchodilators to overcome eventual bronchospasm, and in some cases hyperbaric oxygen therapy (HBO). The range of effects of Hydrogen Sulfide on humans is summarized herein below:

0.0047 ppm (part per million) is the recognition threshold, the concentration at which 50% of humans can detect the characteristic odor of Hydrogen sulfide, normally described as “a rotten egg”.

<10 ppm has an exposure limit of 8 hours per day.

10-20 ppm is the borderline concentration for eye irritation.

50-100 ppm leads to eye damage.

At 100-150 ppm, the olfactory nerve is paralyzed after a few inhalations, and the sense of smell disappears, often together with lack of awareness of danger.

320-530 ppm leads to pulmonary edema with the possibility of death.

530-1000 ppm causes strong stimulation of the central nervous system and rapid breathing, leading to loss of breathing.

800 ppm is the lethal concentration for 50% of humans for 5 minute exposure (LC50).

Concentrations over 1000 ppm cause immediate collapse with loss of breathing, even after inhalation of a single breath.

Some bacteria release Hydrogen Sulfide from sulfur-containing amino acids. In the same way that there are Hydrogen or oxygen producing organisms and those that utilize these gases for generation of energy, similarly some organisms utilize Hydrogen Sulfide as the main substrate for generation of their required energy. The organic residues that remain from early oceans were anoxic (oxygen-depleted) and had species of shallow plankton that metabolized H₂S. The purple sulfur bacteria and the green sulfur bacteria use Hydrogen Sulfide as electron donor in an old form of photosynthesis, as compared to the new form of photosynthesis used by cyanobacteria, algae, and plants, which use water as electron donor and liberate oxygen. Some bacteria generate energy by oxidizing Hydrogen Sulfide to elemental sulfur or to sulfate by using dissolved oxygen, metal oxides (e.g., Fe oxyhydroxides and Mn oxides) or nitrate as oxidant.

Hydrogen Sulfide is widely present in the environment, in food and in cells of diverse origin.

Certain water have Hydrogen Sulfide and this gas is also produced during manufacturing of foods. Dairy products, like butter and cheese, and meat products like beef, chicken and pork are good sources of Hydrogen sulfide. Moreover, processed foods like jellies and candies also naturally contain some amounts of Hydrogen sulfide. In foods such as casing sausages and canned foods produced by a high-temperature heat treatment, Hydrogen Sulfide is generally generated in large amounts due to thermal degradation of protein. Hydrogen Sulfide also exists in alcoholic beverages, as the fermentation of alcoholic beverages such as wine and beer frequently uses yeasts which produce Hydrogen sulfide. Hydrogen Sulfide is of particular importance to alcoholic beverage quality for several reasons: 1) Hydrogen Sulfide has an aroma similar to that of rotten eggs or sewage, even when present at an extremely low level, e.g., 0.5-2 ppb in wine, 2) it is a major mal-odorous volatile sulfur compound produced by yeast during fermentation, 3) other volatile sulfur compounds, such as mercaptans and disulfides responsible for potent off-odor problems in wine and beer, are derived primarily from Hydrogen sulfide. Hydrogen Sulfide is frequently produced during fermentation at levels well above the sensory threshold and can be converted to other volatile sulfur compounds which are the cause of other off-odors, described as “burnt match,” “rubber,” “cooked cabbage,” “onion,” and “garlic.”

The available data show that Hydrogen Sulfide is present in cells in plant and animal kingdom and is required for normal functioning of different organs, tissues and cells. Despite its off-putting odor, it is now realized that Hydrogen Sulfide is present in plants and plays a variety of function (U.S. Pat. No. 4,463,025). Green leaves emit Hydrogen Sulfide when plants are exposed to light, to SO₄²⁻ or SO₂. Plants can reduce SO₄²⁻ to a bound form of sulfide—which is incorporated by a light-driven assimilation pathway—into L-cysteine. Therefore, the conversion of bound sulfide to free sulfide and its release as H₂S is one possible origin of the Hydrogen Sulfide emitted in response to SO₄²⁻. Another possible route to the production of Hydrogen Sulfide from SO₂ is by direct reduction of free SO₃²⁻ to Hydrogen sulfide, which is catalyzed by sulfite reductase. Still another possibility is that L-cysteine could be a precursor of Hydrogen sulfide. L-Cysteine is a precursor of most organic sulfur compounds and it regulates SO₄²⁻ uptake, ATP sulfurylase, adenosine-5′-phosphosulfate sulfo-transferase, thiosulfonate reductase, O-acetylserine sulfhiydrylase, L-serine transacetylase, and nitrogen metabolism. In fact, it has been shown that cucurbit leaves exposed to L-cysteine emit Hydrogen sulfide.

Hydrogen Sulfide is also emerging as a signaling molecule in the human body and plays a significant role in a diversity of cell responses. Hydrogen Sulfide has an anti-inflammatory effect, is antioxidant by enhancing reduced glutathione (GSH, a major cellular antioxidant) and increases the re-distribution of GSH into mitochondria. Hydrogen Sulfide scavenges reactive oxygen species (ROS) and peroxynitrite. Hydrogen Sulfide protects cells against damage and cell death. Hydrogen Sulfide stimulates ATP sensitive potassium channels, causing inhibition of insulin secretion in smooth-muscle cells, neurons, cardiomyocytes, and pancreatic beta-cells. Hydrogen Sulfide is also involved in myocardial contractility, neurotransmission, maintenance of vascular tone, and blood pressure regulation; it also serves as an important neuroprotective agent and protects primary rat cortical neurons from oxidative stress-induced injury. Hydrogen Sulfide shields cells against cytotoxicity caused by peroxynitrite, beta-amyloid, hypochlorous acid, cobalt chloride (CoCl₂, a chemical hypoxia mimetic agent) and H₂O₂ (which activates MAPK) via the suppression of ERK1/2 activation and inhibition of rotenone-induced cell death. Hydrogen Sulfide attenuates lipopolysaccharide (LPS)-induced inflammation in microglia and inhibits LPS-induced NO production in microglia via inhibition of p38MAPK. Hydrogen Sulfide inhibits hypoxia—but not anoxia-induced HIF-1 alpha protein accumulation—but destabilizes HIF-1alpha in a VHL- and mitochondria-dependent manner. Hydrogen Sulfide does not affect neo-synthesis of HIF-1 alpha protein but inhibits HIF-1-dependent gene expression.

Because of its anti-oxidant, anti-inflammatory and cell protecting effects, Hydrogen Sulfide has many beneficial effects. The presence of Hydrogen Sulfide in many plants and herbal medicines has been shown to have beneficial effects in regards to human health. Dietary beneficial health effects of garlic (Allium sativum) have been recognized for centuries. In particular, garlic consumption has been correlated with the reduction in multiple risk factors associated with cardiovascular diseases such as increased reactive oxygen species, high blood pressure, high cholesterol, platelet aggregation, and blood coagulation; however, the active principles and mechanisms of such actions remained elusive. It is now shown that garlic-derived organic poly-sulfides are Hydrogen Sulfide donors via glucose-supported, thiol-dependent cellular and glutathione (GSH)-dependent a-cellular reactions. It has been proposed that the major beneficial effects of garlic rich diets, specifically on cardiovascular disease and more broadly on overall health, are—mediated by the biological production of Hydrogen Sulfide from garlic-derived organic poly-sulfides. Due to Hydrogen sulfide's physiological influence, many diet experts, including members of the WHO Expert Committee, are starting to recommend the inclusion of foods containing Hydrogen Sulfide into the minimum daily requirements of a diet.

It has been shown that the use of Hydrogen Sulfide in the range of 80 ppm leaves no side effects in mice despite the fact that the mice enter a state of suspended animation. In 2005, it was shown that mice can be put into a state of suspended animation-like hypothermia by applying a low dosage of Hydrogen Sulfide (81 ppm H₂S) in the air. The breathing rate of the animals sank from 120 to 10 breaths per minute and their temperature fell from 37° C. to just 2° C. above ambient temperature. The mice survived this procedure for 6 hours and afterwards showed no negative health consequences. In 2006, it was shown that the blood pressure of mice treated in this fashion with Hydrogen Sulfide did not significantly decrease. A similar process known as hibernation occurs naturally in many mammals and also in toads, but not in mice. Mice can fall into a state called clinical torpor when food shortage occurs. If the H₂S-induced hibernation can be made to work in humans, it could be useful in the emergency management of severely injured patients, and in the conservation of donated organs. In 2008, hypothermia induced by Hydrogen Sulfide for 48 hours was shown to reduce the extent of brain damage caused by experimental stroke in rats. As mentioned above, Hydrogen Sulfide binds to cytochrome oxidase and thereby prevents oxygen from binding, which leads to the dramatic slow down of metabolism. Animals and humans naturally produce some Hydrogen Sulfide in their body. It has been proposed that the Hydrogen Sulfide is used to regulate metabolic activity and body temperature, which would explain the above findings. Two recent studies, however, cast doubt about universality of this effect. For example, a 2008 study failed to reproduce these effects in pigs. A different study also failed to show induction of hypo-metabolism in sheep. Thus, the effects seen in mice may not be reproducible in larger mammals.

Hydrogen, oxygen and Hydrogen Sulfide are the main gases that are used by majority of life forms on earth for generation of energy that makes life possible. Besides these gases that exist within and are involved in energy production in biological life forms, there are only two other gases that play important functions in organisms, namely carbon monoxide (CO) and nitric oxide (NO). However, these latter gases are not used for generation of energy and are considered signaling molecules or gasotransmitters. Among these three gases, only Hydrogen Sulfide is used both as a substrate for energy production as well as serving as a signaling molecule. Based on such considerations, Hydrogen Sulfide is unique without having any other known gas counterpart in biological systems.

Industrial Applicability of Hydrogen Sulfide and Hydrogen for Decontamination, Disinfection, and Crop and Food Preservation

There is no single GRAS approved chemical that can replace sulfites in any given application, much less across the range of all applications. Unfortunately, most preservatives are added to the food and for this reason such products are consumed by the consumer. In order to overcome the inherent problems in current techniques, we have developed a practical method for preserving food by providing Hydrogen Sulfide and Hydrogen gases with or without Helium gas in the food environment rather than adding a preservative to the food. Although other combinations of gases might work, the current technology is unique since both Hydrogen Sulfide and Hydrogen gas can be produced safely and released into the environment where food is stored. Moreover, the final waste product(s) can be disposed following usage. Finally, the method is safe, cost effective and does not pose health concerns inherent to the use of chemical preservatives. For example, no Hydrogen Sulfide remains within the Hydrogen Sulfide saturated water after 24 hour of storage. Also, the level of Hydrogen Sulfide in the food does not change or any change does not alter the food taste, color, aroma or consistency. Also, the production of Hydrogen from magnesium hydride generates magnesium hydroxide that is safe. Indeed, the suspensions of magnesium hydroxide in water, often called Milk of Magnesia, is used as an antacid to neutralize stomach acid, and as a laxative. Thus, this method is the only organic method that can be safely used on a variety of food products. Our process preserves food and protect it from invasion of organisms that contaminate food. This method can be used as a insecticidal, funicidal, rodenticidal, pediculicidal, and biocidal method. All food preservations are done by virtue of providing Hydrogen Sulfide with and without Hydrogen and with or without Helium in the environment or within the product to be preserved. Addition of Helium increases the potency of this combination of gases even further and prolongs the shelf life of the food. This can be done by storage of crops or food in an atmosphere containing gaseous Hydrogen Sulfide and Hydrogen or other chemicals that emit these gases into the environment where a product is stored or by rinsing the product with water containing Hydrogen Sulfide or chemicals or organisms that emit it along with the generation and release of Hydrogen from chemical reactions, electrolysis of water or Hydrogen scavengers or by any other means. When needed, the innate protective nature of the food can be enhanced, however, by incorporation of genes of enzymes that make Hydrogen Sulfide and/or Hydrogen into the genome of the plants such that Hydrogen Sulfide and Hydrogen can be produced in sufficient quantity to prolong the life of the fruit and vegetables by cells of the organism. Helium can be added as a gas to the environment or generated within such environment. Although Hydrogen Sulfide has the smell of rotten egg, we adopted a technique to eliminate its odor. We used only amounts of Hydrogen Sulfide that was sufficient to kill organisms in the first 24 hours. The preservation of dis-infected food was then done in presence of Hydrogen with or without Helium. This practice essentially eliminates the odor of the Hydrogen Sulfide and exposure of individuals including workers or consumers to this gas and moreover, maintains the characteristics and freshness of the food by Hydrogen with or without Helium.

Effect of Hydrogen Sulfide and Hydrogen in Food Preservation

It has recently become clear that Hydrogen gas (H₂) exerts an anti-oxidant activity and this activity has been shown to prevent oxidative damage. Hydrogen, is a stable gas that can react only with oxide radical ion (.O⁻) and hydroxyl radical (.OH) in water with low reaction rate constants:

O⁻+H₂→H.+OH⁻k=8.0×10⁷M⁻¹·s⁻¹

OH+H₂→H.+H₂O k=4.2×10⁷M⁻¹·s⁻¹

H.+.OH→H₂O k=7.0×10⁹M⁻¹·s⁻¹

The reaction rate constants of .O⁻ and .OH with other molecules are mostly in the orders of 10⁹ to 10¹⁰ M⁻¹·s⁻¹, whereas those with H₂ are in the order of 10⁷M⁻¹·s⁻¹. Hydrogen, however, is a small molecule that can easily dissipate into cells, and the collision rates of Hydrogen with other molecules are expected to be very high, which is likely to be able to overcome the low reaction rate constants. Hydrogen is not easily dissolved in water, and 100%-saturated Hydrogen water contains only 1.6 ppm or 0.8 mM Hydrogen at room temperature.

The idea that Hydrogen can act as an antioxidant has been tested in the past four and a half years, in 63 disease models in the mouse as well as human diseases. Most studies have been performed on rodents including two models of Parkinson's disease and three models of Alzheimer's disease. Prominent effects are observed especially in oxidative stress-mediated diseases including neonatal cerebral hypoxia; Parkinson's disease; ischemia/reperfusion of spinal cord, heart, lung, liver, kidney, and intestine; as well as in transplantation of lung, heart, kidney, and intestine. Six human diseases have been studied to date: diabetes mellitus type 2, metabolic syndrome, hemo-dialysis, inflammatory and mitochondrial myopathies, brain stem infarction, and radiation-induced adverse effects. Together, such findings provided the proof of hypothesis that Hydrogen as a gas can have anti-oxidative effects. For this reason, we tested whether Hydrogen gas together with Hydrogen Sulfide that also has antioxidant activity can inhibit food ripening and spoilage that are driven by oxidative mechanisms.

FIG. 4 shows the conversion of polyphenol by phenol oxidase to quinone. Enzymes present in fruits, mainly polyphenol oxidase cause the browning in damaged fruits. Normally polyphenol oxidase works in plants as a defense against insects. When activated, this enzyme turns phenols in the plant into quinones, and these quinones then turn into a brown pigment with antibacterial, and anti-fungal and UV protection properties. The conversion of polyphenol by phenol—41 oxidase to quinone—43 is shown in FIG. 4 which was originally described in the nobel lecture by Albert Szent Györgi in 1937 (Nobel Lecture, Albert Szent Györgi Dec. 11, 1937, Oxidation, Energy Transfer, and Vitamins).

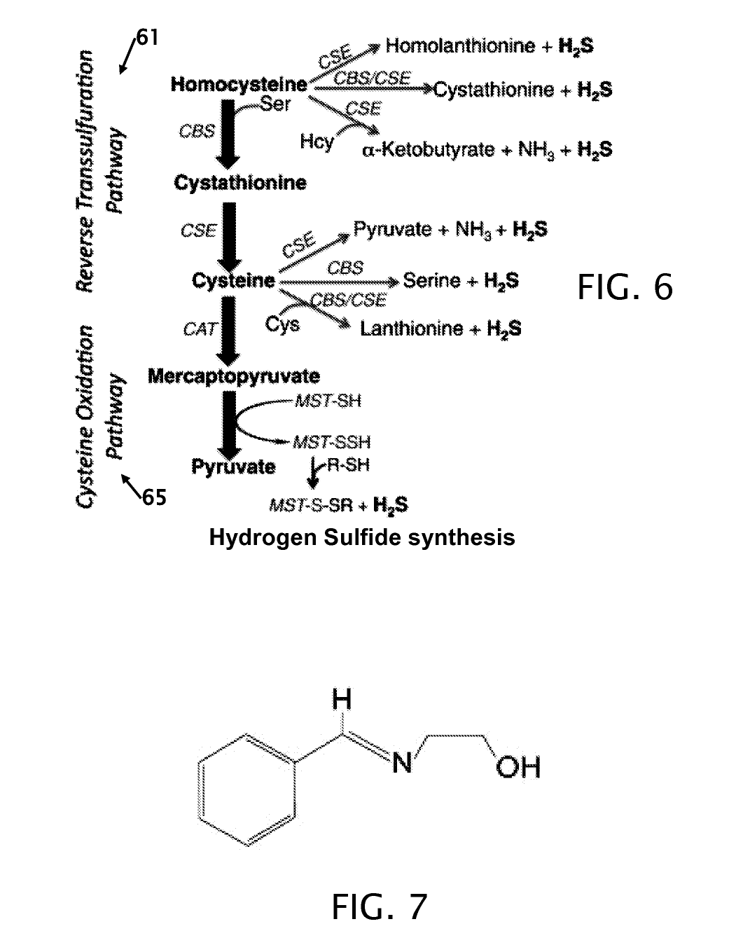

FIG. 5 shows Ethylene pathway. Ripening of mature seed-bearing fresh fruits such as banana, apple, pear, most stone fruits, melons, squash, and tomato involves changes in color, texture, aroma, and nutritional quality. The ripening involves a unique set of developmental and biochemical pathways that lead to the generation of gaseous plant hormone, ethylene. Mechanisms of ethylene perception and response is comprised of both novel components of ethylene signal transduction and unique transcription factor functions that together are involved in ripening-related ethylene production. The findings reported here show that Hydrogen Sulfide, Hydrogen with or without addition of Helium delay the processes which occur during ripening. Similar to Hydrogen Sulfide which is synthesized by trans-fuluration pathway from methionine, ethylene is synthesized from methionine in three steps: (1) conversion of methionine 51 to S-adenosyl-L-methionine (SAM) 53 catalyzed by the enzyme SAM synthetase, (2) formation of 1-aminocyclopropane-1-carboxylic acid (ACC) 55 from SAM via ACC synthase (ACS) activity, and (3) the conversion of ACC to ethylene 57, which is catalyzed by ACC oxidase (ACO). The synthesis of Hydrogen Sulfide occurs in a similar manner from methionine as shown in the FIG. 6. Two branches within the sulfur metabolic pathway—61 contribute to H₂S production: (1) the reverse trans-sulfuration pathway in which two pyridoxal 5′-phosphate-dependent (PLP) enzymes, cystathionine beta-synthase and cystathionine gamma-lyase convert homo-cysteine successively to cystathionine and cysteine and 2) a branch of the cysteine catabolic pathway—65 which converts cysteine to mercaptopyruvate via a PLP-dependent cysteine amino-transferase and subsequently, to mercapto-pyruvate sulfur transferase-bound persulfide from which H₂S can be liberated.

Due to similarity in the synthesis of both ethylene and Hydrogen Sulfide from methionine, we hypothesized and tested whether Hydrogen Sulfide or Hydrogen or Helium gas might compete with or inhibit some of the chemical reactions that lead to fruit ripening. Hydrogen Sulfide might have other functions such as it might bind to and inhibit the function of ACC oxidase similar to its ability to bind to and inhibit the cytochrome C oxidase in mitochondria which is crucial to generation of energy. Regardless of the mode of action, as shown by experiments in this application, Hydrogen sulfide, Hydrogen or Helium inhibit the fruit ripening process and hence increase the post-harvest longevity of fruits.

Since ripening and subsequent food spoilage entails oxidation, we first tested whether Hydrogen alone can prevent food ripening and spoilage and growth of micro-organisms on food that are aerobic and thus require presence of ample oxygen. We generated Hydrogen from various sources including:

Interaction of Magnesium Hydride and water

MgH₂+2H₂O→2H₂+Mg(OH)₂

Interaction of Magnesium and water

Mg+2H₂O→2H₂+Mg(OH)₂

Electrolysis of water

2H₂O(l)→O₂(g)+4H+(aq)+4e⁻

2H₂O(l)+2e⁻→H₂(g)+2 OH⁻(aq) Cathode (reduction)

4 OH⁻(aq)→O₂(g)+2H₂O(l)+4e Anode (oxidation):

These studies show that providing Hydrogen in the food environment can prevent ripening and prolongs food shelf life. Hydrogen reduces but does not eliminate the growth of micro-organisms. FIG. 8 A-B show Hydrogen-mediated fruit preservation at room temperature. These representative images in FIG. 8A show that introduction of Hydrogen gas emitted from a Hydrogen stick (Hayashi water stick) or from electrolysis of water shown in FIG. 8B into a closed environment where fruits are stored at room temperature prevents food spoilage and retards but does not inhibit growth of mold and/or bacteria. Representative samples include but are not limited to (Strawberry, Blackberry, Raspberry, Banana, Tomato and Avocado). Experiments were repeated at least four times and each food category included a minimum of six items in each group. The containers were made of gas impermeable plexi-glass that snugly fitted onto the container rim. Fruits were placed on regular kitchen towels that covered the bottom of the container. Control and experimental group (Exp) of fruits were placed in separate containers. The amount of H₂ gas within the Exp containers varied from 5-45 ppm during the course of exposure. When the level dropped below 5 ppm, the H₂ gas was substituted. Experiment was carried out at room temperature for the durations shown. Spoilage of food is observed in the control group including change in color, consistency, aroma, and flavor as well as growth of yeast and/or bacteria (arrows—10, 12, 14). There is less change in color, consistency, of the H₂ gas-treated group and fruits show less growth of mold (arrows—11, 13, 14). Strawberry 70 and 77. Raspberry 71 and 78, and Blackberry 72 and 79. The initial evidence of yeast growth was seen on day 3 in the control group which is pronounced on day 4 (arrows 10-15). The fruit also lost its consistency and is discolored. Growth of mold in the Exp group is evident on day 4 and is less severe than the control group. Tomato, 73. Control un-ripened tomato shows ripening on day 4. The Exp tomato shows less ripening on the same day in presence of Hydrogen gas. Avocado, 74 and 75. Yeast has covered the slice of avocado in the control group—75. When this surface layer is removed, the brown surface of control un-treated avocado is revealed that shows a brown to black discoloration—75. The Exp avocado shows only moderate surface discoloration and no evidence of growth of yeast on day 4. Bananas 76. Control un-ripened bananas show ripening and surface discoloration on day 4. The Exp bananas show less ripening and discoloration on the same day in presence of Hydrogen gas.

Because Hydrogen does not inhibit the growth of micro-organisms, these studies show that Hydrogen alone cannot be used in food preservation. Thus, addition of another agent that could prevent growth of micro-organisms was required. We chose Hydrogen Sulfide and tested its effect on growth of micro-organisms. We find that Hydrogen Sulfide not only prevents growth of micro-organisms including bacteria, and yeast or mold that spoil food, it prevents food ripening and also maintains freshness of the food and prevents food spoilage and decay.

FIG. 9 shows Hydrogen Sulfide-mediated inhibition of growth of micro-organisms at room temperature. These representative images show that H₂S is germicidal at room temperature. To determine whether H₂S is only bacteriostatic or fungistatic or germicidal, agar plates were streaked with bacteria or yeast and then they were exposed to Hydrogen Sulfide either by introducing NaHS (50 mg, one day), gas (40 ppm, one day) or Hydrogen Sulfide saturated water (0.04%, 1 ml, one day) within a closed environment at room temperature where the streaked agar plates were placed. Control counterparts were also kept at room temperature within a closed environment. Then, the plates were removed from these environments, sealed and placed at room temperature for two months. The representative images in FIG. 9 show that Hydrogen Sulfide generated from Hydrogen Sulfide donor, NaHS, is germicidal. Growth of both bacteria and yeast were evident in the representative control group while no growth was evident in the Experimental (Exp) group.

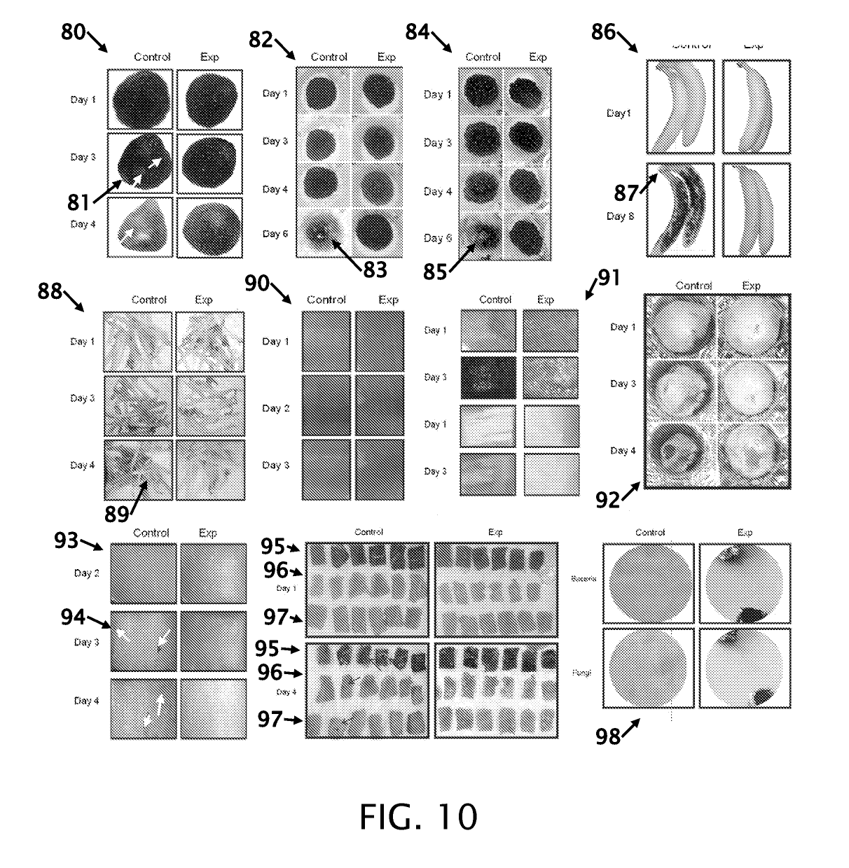

FIG. 10 shows Hydrogen Sulfide-mediated fruit preservation and inhibition of growth of micro-organisms at room temperature. These representative images show that introduction of NaHS that releases H₂S into a closed environment where food is stored at room temperature prevents food spoilage and growth of mold and/or bacteria. Representative samples of foods shown include fruits, vegetables, meat, chicken and salmon. Experiments were repeated at least four times and each food category included a minimum of six items in each group. Foods and fruits were stored in closed containers. The containers were made of aluminum with a plastic lid that snugly fitted onto the container rim. Foods and fruits were placed on regular kitchen towels that covered the bottom of the container. Control group (Control) of foods and fruits were stored within the containers. The experimental group (Exp) of foods and fruits were placed in the same type of containers and 500 mg of NaHS was placed in a glass cup which was placed in one corner of the container of the Exp group. The containers were not sealed. Using a H₂S gas detector capable of detecting 1 to 500 ppm of H₂S, no H₂S was detected outside the containers. The amount of gas within the Exp containers varied from 5-40 ppm during the course of exposure. When the level of Hydrogen Sulfide dropped below 5 ppm, the NaHS was substituted. Experiments were carried out at room temperature for the durations shown. Spoilage of food is observed in the control group including change in color, consistency, aroma, and flavor as well as growth of yeast and/or bacteria. There is small change in color, consistency, and of the same food group and there is no evidence of growth of yeast in the NaHS treated group. Strawberry 80. The initial evidence of yeast growth was seen on day 3 (arrow 81) in the control group which is pronounced on day 4 (arrow). The fruit also lost its consistency and is discolored. These changes are not seen in the Exp group. Raspberry 82. Growth of yeast is seen by day 4 and is pronounced on day 6 (arrow 83) in the control group. The fruit also lost its consistency and is discolored. These changes are not seen in the Exp group. Blackberry 84. Growth of yeast is seen by day 4 which is pronounced by day 6 (arrow 85) in the control group. The fruit also lost its consistency and is discolored. These changes are not seen in the Exp group. Banana 86. Growth of yeast is seen by day 8 (arrow 87) in the control group. The fruit also lost its consistency and is discolored. These changes are not seen in the Exp group. Sprout 88. Growth of yeast and bacteria is seen by day 4 (arrow 89) in the control group. Sprout also lost its consistency and is discolored. These changes are not seen in the Exp group. Leek 90. The vegetable is discolored in the control group by day 3. These changes are not seen in the Exp group. Avocado 91. Avocado was either homogenized (top two rows) or cut into small 1×1 cm pieces (bottom two rows) and stored in the containers. Both homogenized as well as cut piece show evidence of severe discoloration on day 3 in the control group while those stored in presence of NaHS have maintained nearly the same color as that on day 1. Mushroom 92. Mushroom is discolored in the control group. These changes are less severe in the Exp group. Cantaloupe 93. Growth of yeast is seen by day 3 and is severe on day 4 (arrows 94) in the control group. The fruit also lost its consistency and is discolored. These changes are not seen in the Exp group. Red meat 95 (top), Chicken 96 (middle) and Salmon 97 (Bottom). The control container developed a foul smell on day 3 which was pronounced on day 4. Larvae developed on day 3 in the control group and flies were found on day 4 in the control group. Meat discolored in the Exp group on day 4 but there was no evidence of foul smell or flies in this group. Agar plate cultures, 98. Samples from each fruit were diluted in phosphate buffered saline, pH 7.4. From each sample, 20 microliters was streaked on agar plates and plates were maintained either at room temperature or at 37° C. Samples from control group yielded bacteria or yeast only from control group. To directly test growth of these bacteria and yeast in presence of NaHS, samples of bacteria and yeast were streaked on agar plates and then stored without or with NaHS. 50 mg of NaHS was placed in an aluminum chamber and these were inserted on both sides of the Exp Petri dishes. Petri dishes were placed at room temperature or at 37° C. Colonies of bacteria and yeast were evident in the control group on day 1 and coalesced by day 3 as shown in the representative cultures 98. However, no growth was evident in cultures maintained in presence of NaHS. No growth was found for up to 2 months following initiation of cultures.

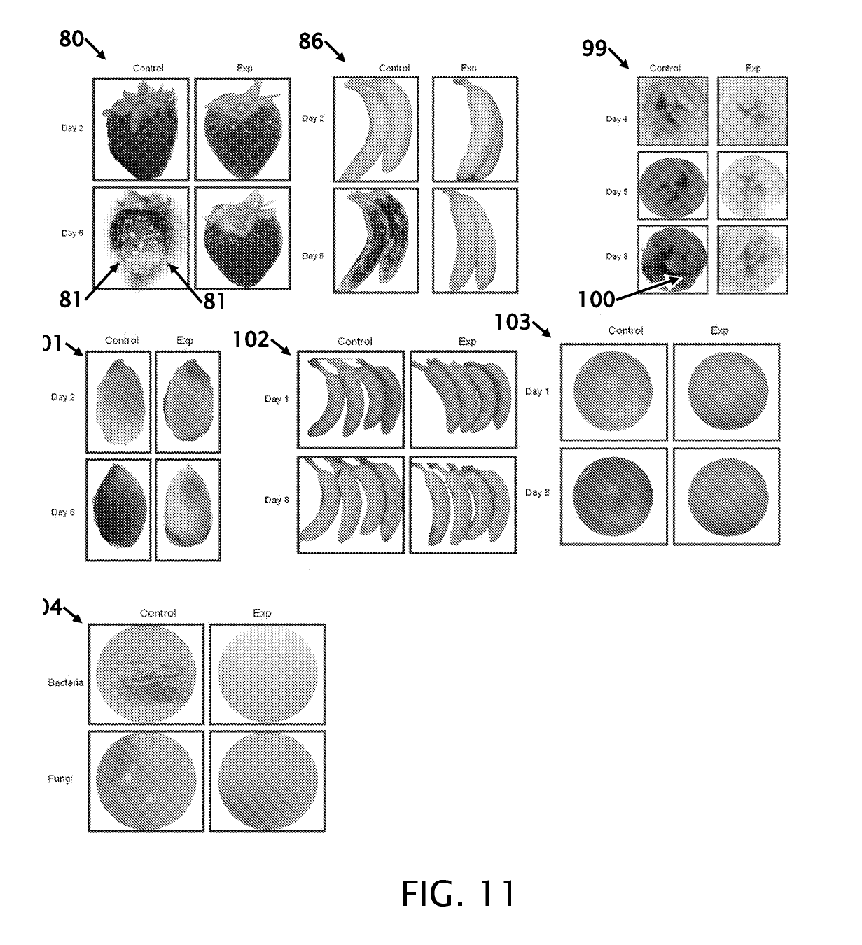

FIG. 11 shows Hydrogen Sulfide-mediated fruit preservation and inhibition of growth of micro-organisms at room temperature. These representative images show that introduction of H₂S gas into a closed environment where whole food is stored at room temperature prevents food spoilage and growth of mold and/or bacteria. Representative samples of foods shown include fruits, and vegetables. Experiments were repeated at least four times and each food category included a minimum of six items in each group. Control foods were stored in closed containers. The containers were made of aluminum with a plastic lid that snugly fitted onto the container rim. Foods were placed on regular kitchen towels that covered the bottom of the container. The experimental group (Exp) of food were placed in an air tight chamber which was flushed with H₂S gas released from a canister of H₂S (40 ppm) from an inlet valve until the outlet valve reading by a H₂S gas monitor showed 40 ppm. The inlet and outlet valves were then closed. Using a H₂S gas detector capable of detecting 1 to 500 ppm of H₂S, no H₂S was detected outside the chamber. Experiment was carried out at room temperature for the durations shown. Spoilage of food is observed in the control group including change in color, consistency, aroma, and flavor as well as growth of yeast and/or bacteria. There is small change in color, consistency, and of the same food group and there is no evidence of growth of yeast in the H₂S gas-treated group. Growth of bacteria and yeast was checked by taking samples of food and streaking them over agar. In each case, yeast and/or bacteria grew from the spoiled control food and in no case, any was detected in the experimental group. Strawberry 80. The initial evidence of yeast growth was seen on day 3 in the control group. This growth was quite evident on day 5 (arrows, 81). The fruit also lost its consistency and is discolored. These changes are not seen in the Exp group nor any growth of yeast or bacteria is seen. Banana, 86. Growth of yeast is seen by day 8 in the control group. The fruit also lost its consistency and is discolored. These changes are not seen in the Exp group of Banana. A slice of banana 99. A slice of banana shows yeast (arrow 100) by day 8 in the control group. The fruit also lost its consistency and is discolored. These changes are not seen in the Exp group. Pistachio 101. The control pistachio is discolored by day 8 while the one in the Exp group shows only moderate change in skin color of Banana. Green bananas 102. Green bananas in each group were used in this experiment. The control bananas ripened, developed a yellow color that still maintained some of their green color on day 8. Tomatoes 103. Green tomatoes in each group were used in this experiment. The control tomato shows ripening as evident by development of its red color while the Exp tomato still maintains its green un-ripened appearance by day 8. Samples from each fruit were diluted in phosphate buffered saline, pH 7.4. From each sample, 20 microliters was streaked on agar plates and plates were maintained either at room temperature or at 37° C. Samples from control group yielded bacteria or yeast only from control group (strawberry in 80, banana in 86 and 99, and pistachio 101). Testing for presence of bacteria and yeast 104. To directly test growth of these bacteria and yeast in presence of H₂S, samples of bacteria and yeast were streaked on agar plate and then stored without or with H₂S. Agar plates were placed at room temperature or at 37° C. Control agar plates were stored in containers while those in the Exp group were introduced to an air tight chamber and gas was introduced to the chamber until the H₂S in the chamber reached to 40 ppm. Colonies of bacteria and yeast were evident on day 1 and coalesced by day 3 as shown in the representative culture. However, no growth was evident in cultures maintained in presence of H₂S gas. No growth was found for up to 2 months following initiation of cultures.

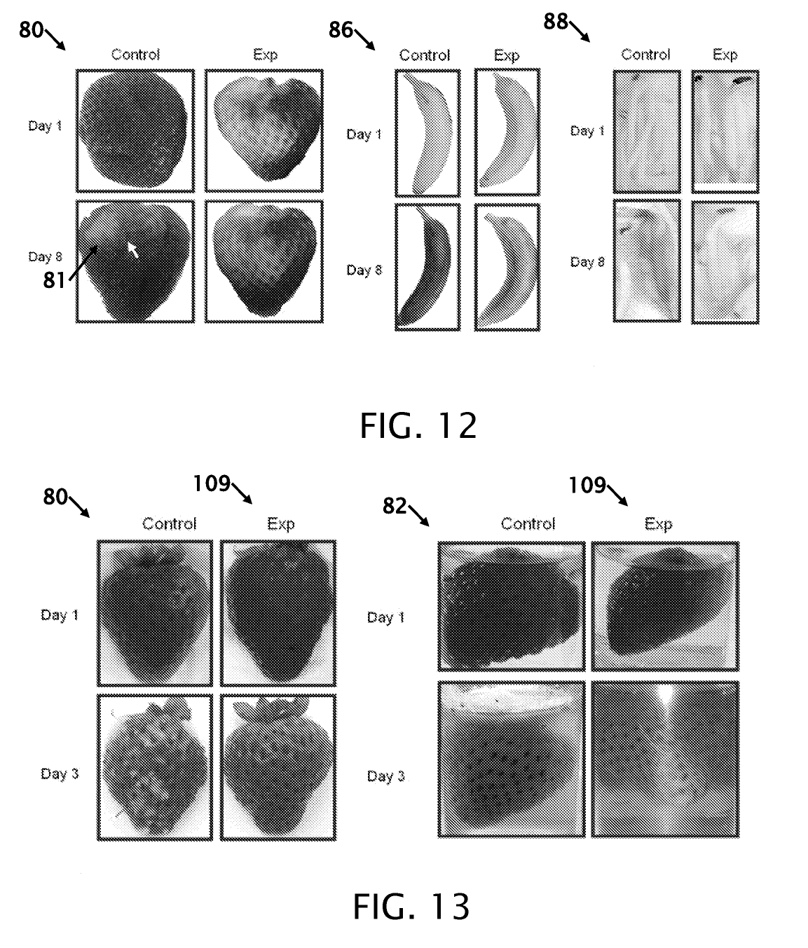

FIG. 12 shows Hydrogen Sulfide-mediated food preservation and inhibition of growth of micro-organisms at room temperature. These representative images show that introduction of H₂S gas released from H₂S saturated (0.04%) water into a closed environment where whole food is stored at room temperature prevents food spoilage and growth of mold and/or bacteria. Experiments were repeated at least four times and each food category included a minimum of six items in each group. Foods were stored in closed containers. The containers were made of aluminum with a plastic lid that snugly fitted onto the containers rim. Foods (Control and experimental “Exp”) were placed on regular kitchen towels that covered the bottom of the containers. The H₂S saturated water (0.04%, 5 ml) was placed in a small cup and placed in one corner of the container of the Exp group. H₂S gas detector registered gas within the container ranging from 5-15 ppm. H₂S was not detected outside the container. Experiment was carried out at room temperature for the durations shown. Spoilage of food is observed in the control group including change in color, consistency, aroma, and flavor as well as growth of yeast and/or bacteria. There is small change in color, consistency, and of the same food group and there is no evidence of growth of yeast in the H₂S gas treated group. Growth of bacteria and yeast was checked by taking samples of food and streaking them over agar. Samples from each fruit were diluted in phosphate buffered saline, pH 7.4. From each sample, 20 microliters was streaked on agar plates and plates were maintained either at room temperature or at 37° C. In each case, yeast and/or bacteria grew from the spoiled control food and in no case, any was detected in the experimental group of Strawberry 80. The initial evidence of yeast growth was seen on day 5 in the control group. This growth was quite evident on day 8 (arrow, 81). The fruit also lost its consistency and is discolored. These changes are less severe in the Exp group. Banana 86. The fruit has lost its consistency and is discolored in the control group on day 8. These changes are less pronounced in the Exp group. Sprout 88. The vegetable is discolored in the control group on day 8. These changes are minimal in the Exp group.

FIG. 13 shows Hydrogen Sulfide-mediated food preservation and inhibition of growth of micro-organisms at room temperature. These representative images show that rinsing or immersion of food in H₂S saturated (0.04%) water prevents food spoilage and growth of mold and/or bacteria at room temperature. Experiments were repeated at least four times and each food category included a minimum of six items in each group. Experiment was carried out at room temperature for the durations shown. Spoilage of food is observed in the control group including change in color, consistency, as well as growth of yeast. Strawberry, 80. Strawberry was rinsed in water (control) or in H₂S saturated (0.04%) water (Exp). Strawberry 82. Strawberry was immersed in water (control) or in H₂S saturated (0.04%) water (Exp). The initial evidence of yeast growth was seen on day 3 in the control group rinsed with water 80 and 82. No change in color or consistency of fruit nor any growth of mold is seen in Exp fruit rinsed with H₂S saturated (0.04%) water. Control strawberry shows change in consistency and growth of yeast. There is a small change in color, consistency, and there is no evidence of growth of yeast in the H₂S treated group 109. Growth of bacteria and yeast was checked by taking samples of food and streaking them over agar. Samples from each fruit were diluted in phosphate buffered saline, pH 7.4. From each sample, 20 microliters was streaked on agar plates and plates were maintained either at room temperature or at 37° C. In each case, yeast and/or bacteria grew from the spoiled control food and in no case, any was detected in the experimental group.

We also tested the impact of Hydrogen Sulfide (H₂S) supplied by its donor, sodium hydrosulfide (NaHS) mixed with water. Aqueous NaHS solutions (0.25-3.5 mmol/L) could release H₂S gas (10⁻¹²˜10⁻¹⁰ mol/L). H₂S rapidly, reached to the highest levels within several minutes and maintained a constant concentration. 1.5 mmol/L-3.0 mmol/L was the most optimal concentration of NaHS for maintaining the freshness of the fruits and vegetables. The NaHS solution was renewed every 48 or 72 hours. The NaHS solution was placed in a sealed container separated by a partition board with pores on it. The fresh cut vegetables including Broccoli, Lettuce, Lotus Root, Yam, Pumpkin, Sweet Potato, Potato, etc, and the fresh cut fruits Apple, Pear, Kiwi Fruit, Tomato, Hami Melon, and Peach were placed above the board, while the NaHS solution was placed under the board. Therefore, the fresh cut vegetables and fruits were fumigated with H₂S gas released from NaHS in the solution. Vegetables and fruits fumigated with the released H₂S at low concentrations kept their water preservation and balance, and lost less water. This treatment also prolonged the time for development of yellowing, browning and wilting. In the meantime, fumigation with H₂S decreased the moldy rate, and slowed the aging process. As compared with the un-treated controls, the storage time and shelf life of vegetables and fruits treated with H₂S fumigation prolonged shelf life from 0.5 days to 12 days.

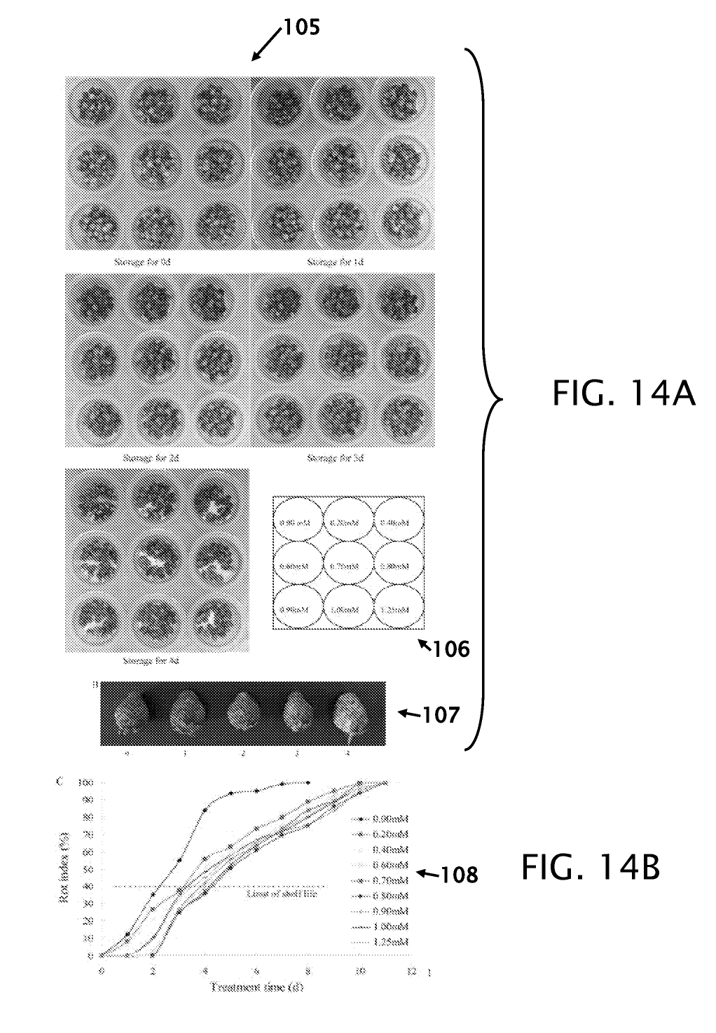

FIG. 14A shows the effect of H₂S on post-harvest shelf life and rot index in strawberry fruits and FIG. 14B shows a graph of exposure to 0, 0.2, 0.4, 0.6, 0.7, 0.8, 0.9, 1.0, and 1.25 mmol/L NaHS for 0-4 days. 105 shows photographs of strawberries after exposure to 0, 0.2, 0.4, 0.6, 0.7, 0.8, 0.9, 1.0, or 1.25 mmol/L⁻¹ NaHS for 0-4 days, respectively. 106 shows the treatments. 107 shows photographs of classification standard for investigating rot index of strawberries. Graph 108 shows the changes in rot index of strawberries treated with different concentrations of NaHS (0, 0.2, 0.4, 0.6, 0.7, 0.8, 0.9, 1.0, and 1.25 mmol/L).

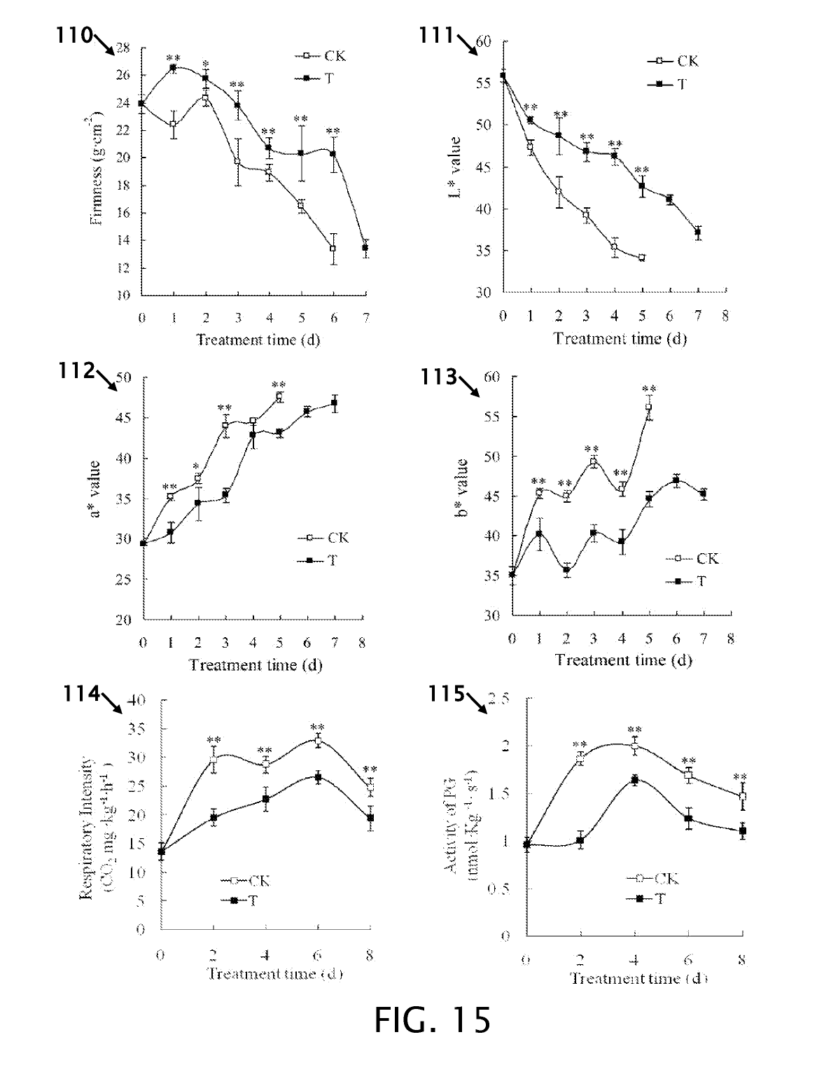

FIG. 15 shows graphs of Hydrogen Sulfide-mediated food preservation. Effect of H₂S on changes in firmness, external color, respiratory intensity, and PG activity in strawberry fruits treated with H₂O (shown as CK) and 0.8 mmol/L⁻¹ H₂S donor NaHS (shown as T). 110 shows change of firmness in strawberries during storage at 20° C. Data are presented as means±SD (n=5). 111 shows change of L* value in strawberries during storage at 20° C. L* indicates lightness. Data are presented as means±SD (n=10). 112 shows change of a* value in strawberries. a* indicates chromaticity on a green (−) to red (+) axis. Data are presented as means±SD (n=10). 113 shows change of b* value in strawberries during storage at 20° C. b* indicates chromaticity on a blue (−) to yellow (+) axis. Data are presented as means±SD (n=10). 114 shows changes of respiratory intensity in strawberries during storage. 115 shows changes of PG activities in strawberries during storage. Data are presented as means±SD (n=3). * and ** mean significance of difference between control (CK) and treated (T) at P<0.01 and P<0.05, respectively.

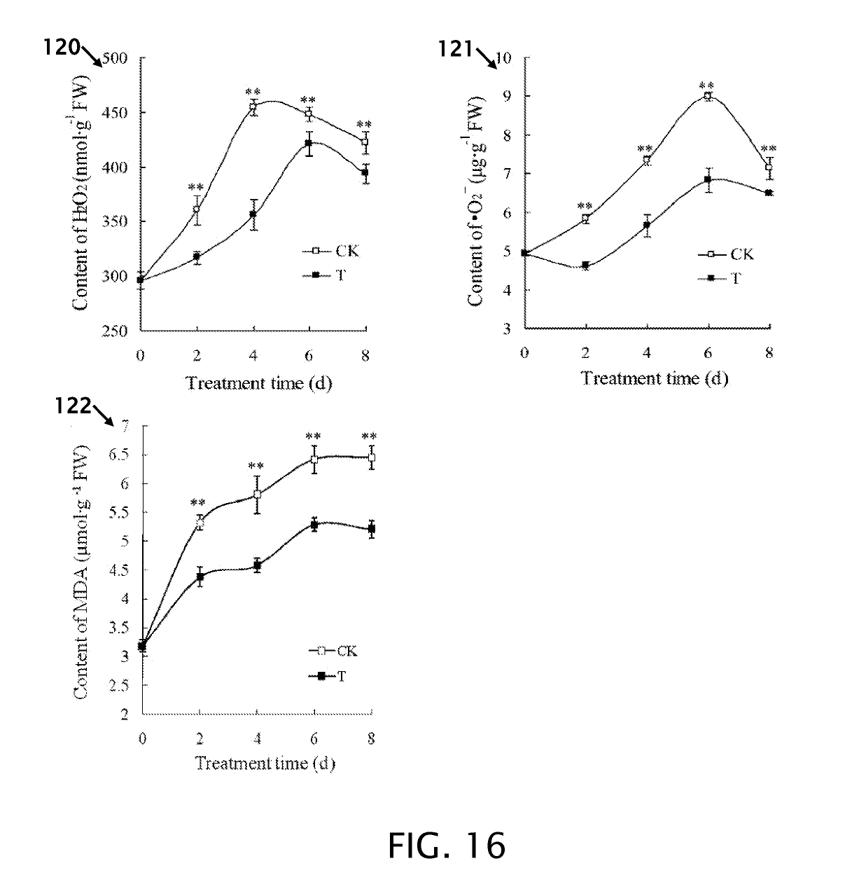

FIG. 16 shows graphs of using Hydrogen Sulfide-mediated food preservation. Effect of H₂S on the contents of Hydrogen peroxide120, superoxide anion 121 and malondialdehyde 122 in strawberries during storage at 20° C. Data are presented as means±SD (n=3). * and ** mean significance of difference between control (CK) and treated (T) at P<0.01 and P<0.05, respectively.

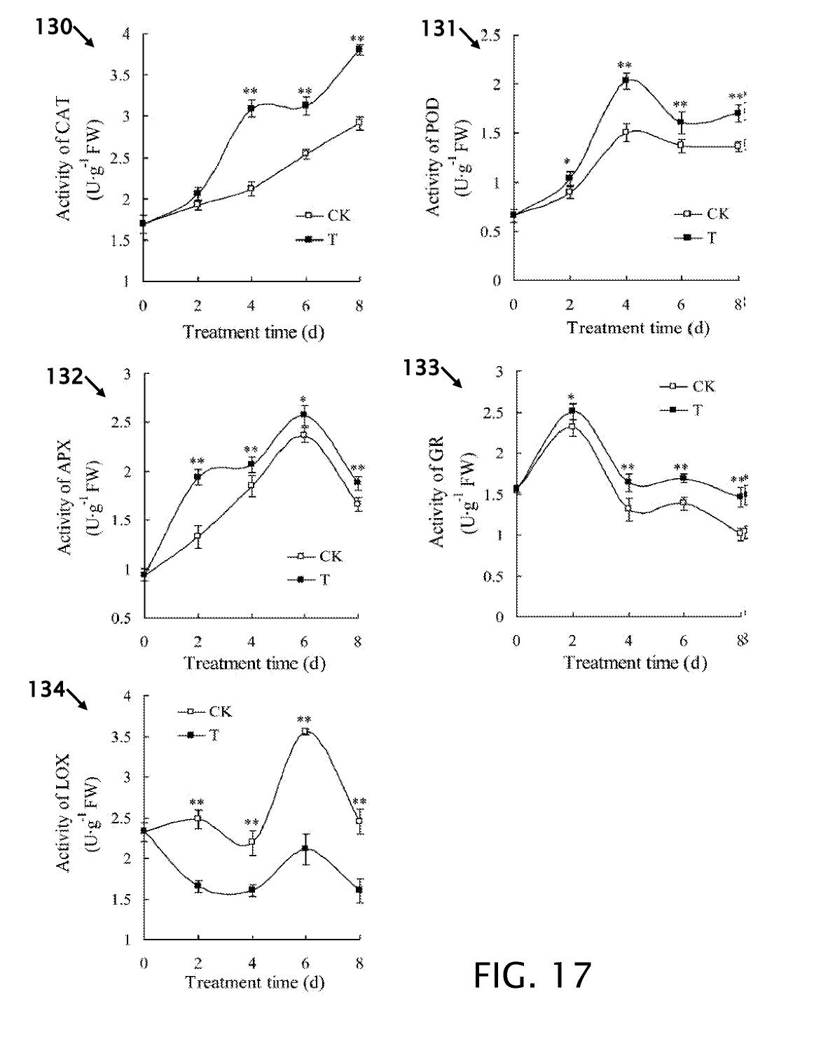

FIG. 17 shows graphs of using Hydrogen Sulfide-mediated food preservation. Effect of H₂S on the activities of catalase 130, guaiacol peroxidase 131, ascorbate peroxidase 132, glutathione reductase 133, and lipoxygenase 134 in strawberries during storage at 20° C. Data are presented as means±SD (n=3) * and ** mean significance of difference between control (CK) and treated (T) at P<0.01 and P<0.05, respectively.

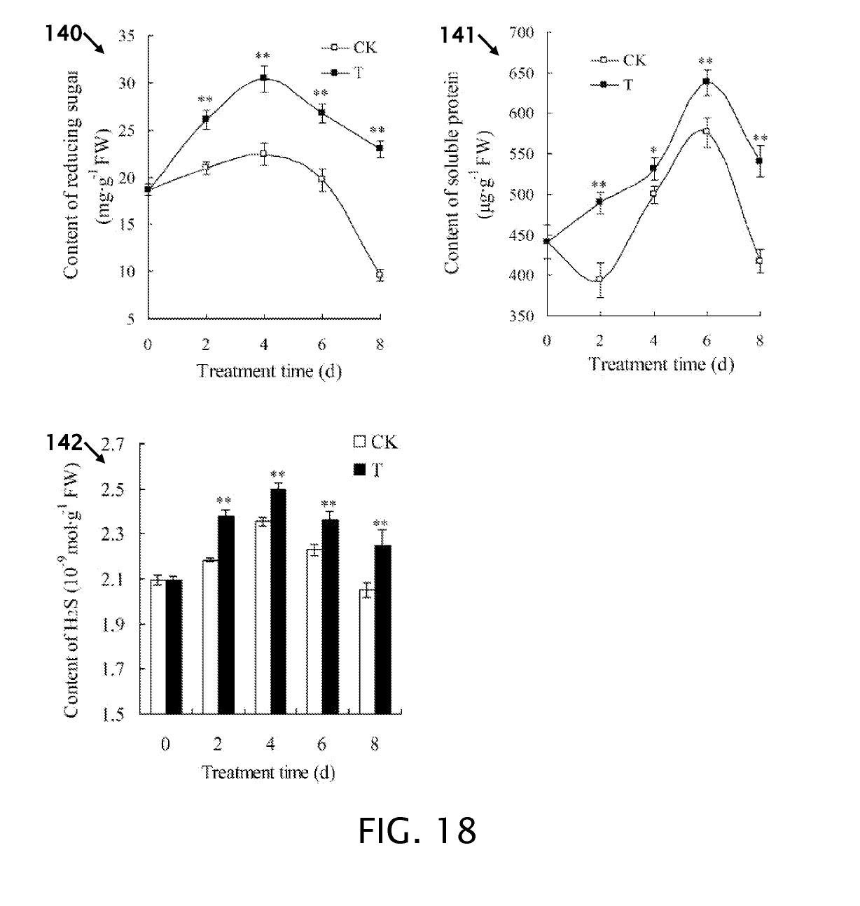

FIG. 18 shows graphs of using Hydrogen Sulfide-mediated food preservation. Effect of H₂S on the contents of reducing sugars140, soluble proteins141, and endogenous H₂S 142 in strawberries during storage at 20° C. Data are presented as means±SD (n=3) * and ** mean significance of difference between control (CK) and treated (T) at P<0.01 and P<0.05, respectively.

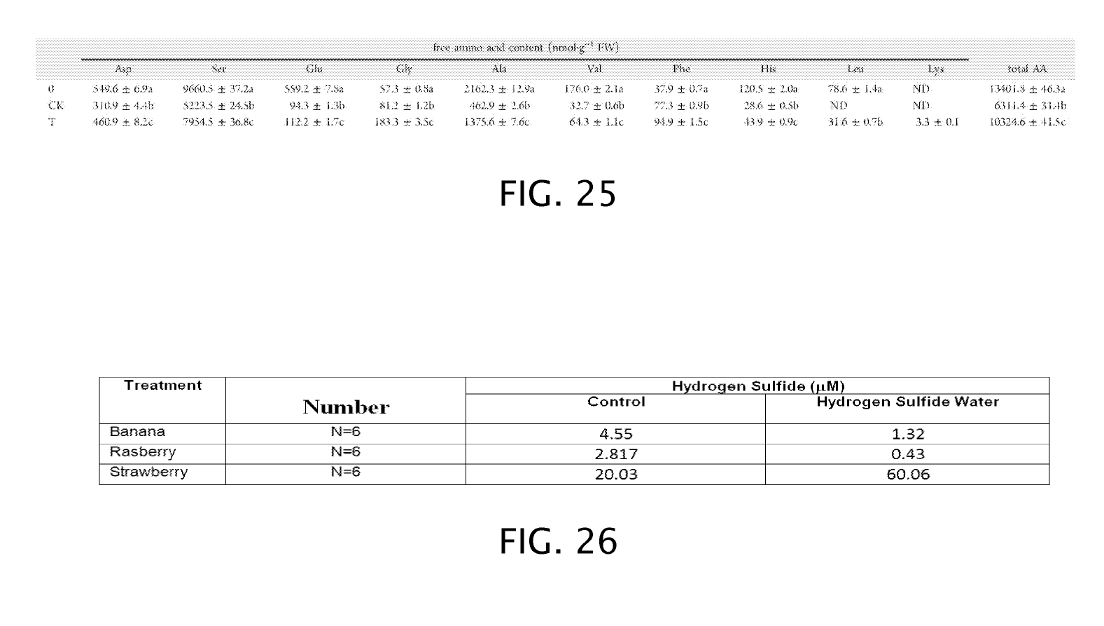

FIG. 25 shows a table of the effect of H₂S on free amino acid content of strawberries during storage at 20° C. Strawberries were treated with H₂O (shown as CK) or with 0.8 mmol·L⁻¹ NaHS solution (shown as T) for 4 days and then fruits were prepared for amino acid determination. 0 represents freshly harvested fruits; CK: Control treated with H₂O , and T: Treated with NaHS. ND, not detected. Thr, Cys, Met, Ile, Tyr, and Arg could not be detected in fruits. Different letters mean significance of difference between the control and treated group (P<0.01, ANOVA, P-test LSD).

1. Freshly Cut Broccoli.

The controls of fresh cut broccoli that were treated with water (0.0 mmol/L NaHS) solution lost their edibility on day 3, while the shelf life of freshly cut broccoli treated with 0.25 mmol/L-1.75 mmol/L NaHS solution was prolonged by 2-3 days. 1.5 mmol/L H₂S donor NaHS solution was shown to be the most optimal concentration and prolonged the shelf life of broccoli by 3 days. The control of freshly cut broccoli treated with 0.0 mmol/L NaHS solution underwent rot process (due to physiological senescence and microbe infection) at 4 days, and the moldy rate reached 100%. In contrast, the treatment with 1.5 mmol/L H₂S donor, NaHS, inhibited the infection by micro-organisms, and no infection appeared until day 9.

2. Freshly Cut Pears and Peaches.

The control of freshly cut pears and peaches that were treated with water (0.0 mml/L NaHS), lost their edibility on day 2, while the shelf life of freshly cut pear and peach treated with 0.5 mmol/L-2.0 mmol/L NaHS solution was prolonged by 1-2 days. 1.5 mmol/L H₂S donor NaHS solution was shown to be the best concentration and prolonged the shelf life by 2 days. The control freshly cut pears and peaches treated with 0.0 mmol/L NaHS solution underwent rot process (due to physiological senescence and microbe infection) in 2.5 days, and the moldy rate reached 100% in 4 days. In contrast, the treatment with 1.5-2.0 mmol/L of NaHS as H₂S donor inhibited the infection by micro-organisms, and micro-organisms did not appear until day 5 and reached to 80% moldy rate after 10 days.

3. Freshly Cut Kiwi Fruits.

The control freshly cut Kiwi fruits that were treated with water (0.0 mmol/L NaHS) lost their color and their edibility completely on day 4, while the shelf life of freshly cut Kiwi fruits treated with 0.25 mmol/L-1.75 mmol/L NaHS solution was prolonged by 2-3 days. 1.5 mmol/L NaHS solution was shown to be the best concentration that prolonged the shelf life of Kiwi by 2 days. The control freshly cut Kiwi fruits treated with 0.0 mmol/L NaHS solution underwent rot process in 5 days, and the rot rate reached 100% in 7 days. In contrast, the treatment of freshly cut Kiwi fruits with 1.5 mmol/L NaHS inhibited the infection by micro-organisms, and micro-organisms did not appear until day 10.

4. Freshly Cut Yams, Sweet Potatoes, and Potatoes.

The control freshly cut yams, sweet potatoes and potatoes that were treated with water (0.0 mmol/L NaHS) underwent browning at 10˜12 hours, while the browning time of freshly cut yams, sweet potatoes and potatoes treated with 0.25-1.75 mmol/L NaHS solution was postponed by about 15-20 hours. Treatment with 1.0-1.5 mmol/L H₂S donor, NaHS, solution was shown to be the most optimal concentrations and postponed the browning time by 16-20 hours.

5. Freshly Cut Chips of Lettuce and Lotus Roots.

The control freshly cut chips of lettuce and lotus roots that were treated with water (0.0 mmol/L NaHS) lost their water and edibility after 15-24 hours, while the freshness of freshly cut chips of lettuce and lotus roots treated with 0.1 mmol/L-1.0 mmol/L NaHS solution was prolonged by 12-18 hours. Treatment with 0.8 mmol/L-1.0 mmol/L NaHS solution as H₂S donor showed the best effect on freshness, maintaining and prolonging it by 18 hours.

6. Freshly Cut Chips of Cantaloupe.

The control freshly cut chips of cantaloupe that were treated with water (0.0 mmol/L NaHS) lost their color and became brown, while the freshness of freshly cut chips of cantaloupe treated with 0.05 mmol/L-1.5 mmol/L NaHS solution was prolonged by 8-12 hours. Treatment with NaHS solution with 0.9 mmol/L-1.0 mmol/L showed the best effect on freshness and maintained and prolonged it by 12 hours.

7. Freshly Cut Tomatoes at Breaker Stage.

The control freshly cut tomatoes that were treated with water (0.0 mmol/L NaHS) gradually turned red, and reached 100% maturation on day 5, while the maturation time of freshly cut tomatoes treated with 0.5 mmol/L-3.5 mmol/L NaHS solution was prolonged by 4-5 days. Treatment with 1.5 mmol/L-2.0 mmol/L H₂S donor NaHS showed the best effect and prolonged the senescence time by 5 days.

FIG. 26 shows a table of concentration of Hydrogen Sulfide in fruits that were maintained in presence of Hydrogen Sulfide saturated (0.04%) water during storage at room temperature. Fruits were left in the absence or presence of 5 ml of Hydrogen Sulfide statured water (0.04%). At the end of 48 hours, the juice of each fruit was extracted and subjected to analysis of Hydrogen Sulfide with the TBR4100 W/LAB-TRAX-4, a H₂S analyzer (World precision instrument, Sarasota, Fla.) which has a sensitivity of less than 5 nM of H₂S. The mean amount of H₂S is shown in the table of FIG. 26. We find that there is no significant increase in levels of Hydrogen Sulfide within the food after exposure to Hydrogen Sulfide saturated (0.04%) water in bananas or raspberries. Although, some increase in the level of Hydrogen Sulfide was observed in the treated strawberries, the increase in the level of Hydrogen Sulfide in the strawberries did not alter their taste.

Preservation of food by Hydrogen Sulfide entails exposing food to water saturated with Hydrogen Sulfide or with the gas directly; however,

Given that Hydrogen and Hydrogen Sulfide prevented food spoilage and that Hydrogen Sulfide prevented growth of micro-organisms, we tested whether the combination of both gases can further improve food preservation and prevent food spoilage. Moreover, Hydrogen Sulfide has a rotten egg odor, so we tested whether an initial dose of Hydrogen Sulfide that is sufficient to eradicate micro-organisms can sustain the freshness of food by co-administration of Hydrogen with and without Helium while leaving no residual odor of the Hydrogen Sulfide after the first 24 hr of treatment.

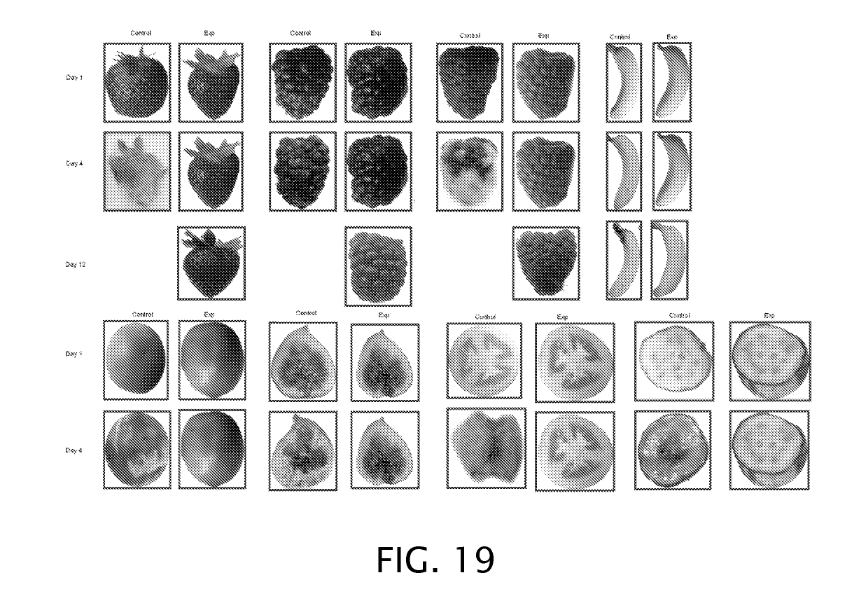

FIG. 19 shows Hydrogen and Hydrogen Sulfide-mediated fruit preservation at room temperature. These representative images show that introduction of H₂ gas emitted from electrolysis of water along with H₂S generated from 0.04% H₂S saturated water into a closed environment where fruits is stored at room temperature prevents food spoilage and inhibits growth of mold and/or bacteria. H₂S gas detector registered gas within the container ranging from 5-15 ppm. H₂S was not detected outside the container. Representative samples include Strawberry, Blackberry, Raspberry, and slices of Banana, Fig, and Tomato. Experiments were repeated at least four times and each food category included a minimum of six items in each group. The containers were made of gas impermeable Plexiglas that snugly fitted onto the container rim. Fruits were placed on regular kitchen towels that covered the bottom of the container. Control (un-treated) and experimental group (Exp) of fruits were placed in separate containers. The amount of H₂S—H₂ gas within the Exp containers varied from 15 (at the beginning of the experiment) to 0 (at the end of the experiment) ppm during the course of exposure. 0.04% H₂S saturated water was placed in the container at the beginning of the experiment and was not replaced throughout the duration of the experiment. Experiment was carried out at room temperature for the durations shown. Spoilage of food is observed on day 4 in the control group including change in color, consistency, aroma, and flavor as well as growth of yeast and/or bacteria. There was no change in color, consistency, and of the same fruits group at the same time frame in the H₂S—H₂ gas treated group. Growth of bacteria and yeast was checked by taking samples of food and streaking them over agar. Samples from each fruit were diluted in phosphate buffered saline, pH 7.4. From each sample, 20 microliters was streaked on agar plates and plates were maintained either at room temperature or at 37° C. In each case, yeast and/or bacteria grew from the spoiled control food and in no case, any was detected in the experimental group.

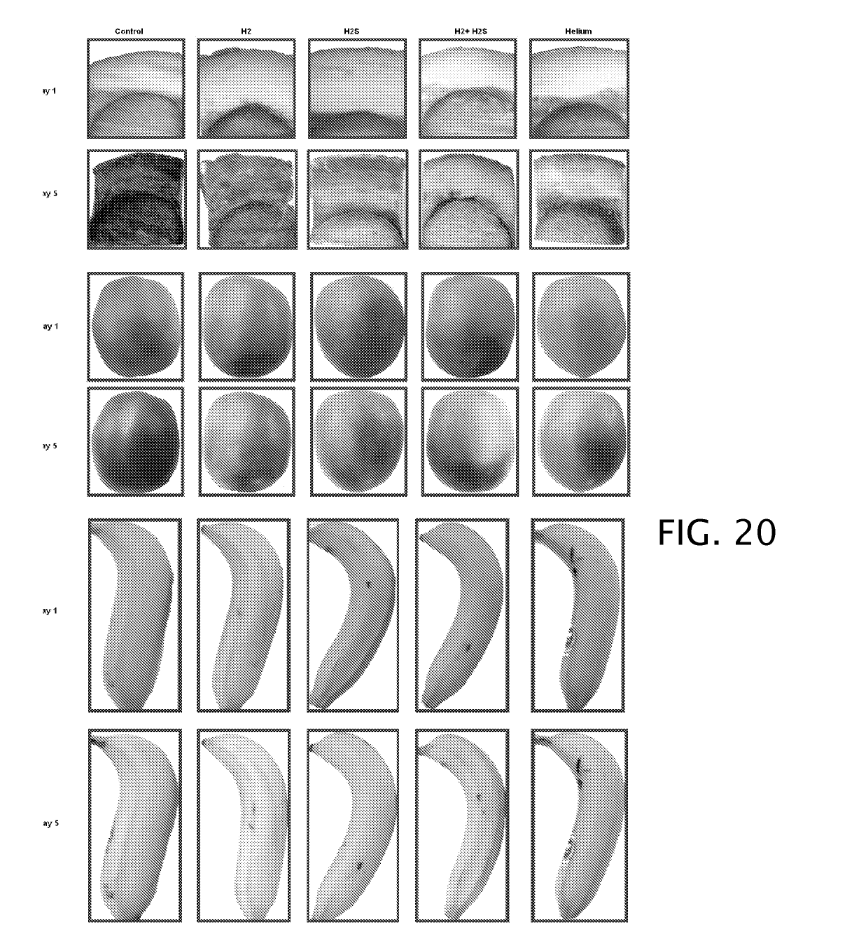

FIG. 20 shows, Hydrogen, Hydrogen Sulfide and Helium-mediated fruit preservation at room temperature. These representative images show that introduction of H₂ gas emitted from electrolysis of water, H₂S generated from NaHS, Helium gas or H₂ gas with H₂S generated from NaHS into a closed environment where whole food is stored at room temperature prevents food spoilage. Representative samples include fruits (Banana), and vegetables (Tomato) and slices of avocado. Experiments were repeated at least four times and each food category included a minimum of six items in each group. The containers were made of gas impermeable Plexiglas that snugly fitted onto the container rim. Fruits were placed on regular kitchen towels that covered the bottom of the containers. Control and experimental group (Exp) of fruits were placed in separate containers. The amount of H₂S—H₂ gas within the Exp containers varied from 5-15 ppm during the course of exposure. When the level dropped below 5 ppm, the H₂ gas was substituted. Experiment was carried out at room temperature for the durations shown. Spoilage of food was observed on day 5 in the control group including change in color, consistency, aroma, and flavor as well as growth of yeast and/or bacteria. There was no change in color, consistency, of the same fruits group at the same time frame in the H₂S—H₂ gas treated group and fruits showed no evidence of growth of mold or bacteria even by day 12 when the fruits and vegetabless lost their consistency, color and aroma. While the control group showed ripening by day 5, the treatment prevented ripening of tomatoes and bananas. Growth of bacteria and yeast was checked by taking samples of food and streaking them over agar. Samples from each fruit were diluted in phosphate buffered saline, pH 7.4. From each sample, 20 microliters was streaked on agar plates and plates were maintained either at room temperature or at 37° C. In each case, yeast and/or bacteria grew from the spoiled control food and in no case, any was detected in the experimental group.

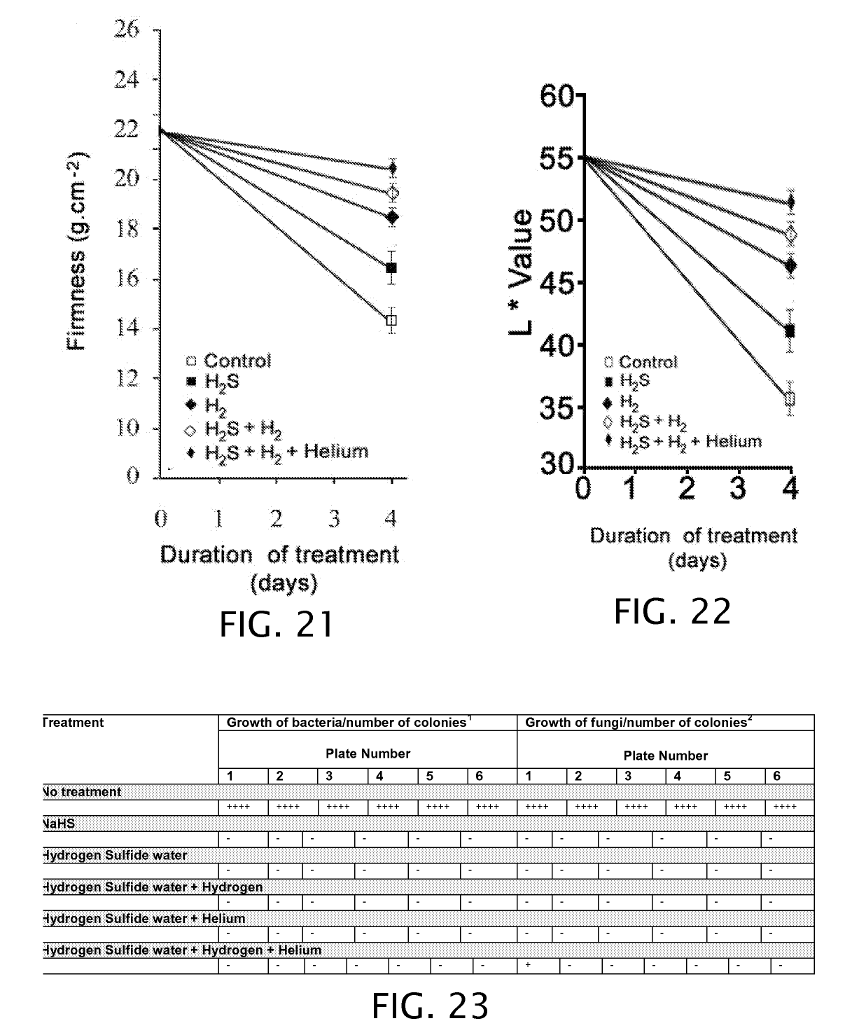

FIG. 21 shows a graph of the effect of Hydrogen, Hydrogen Sulfide, and Helium and their combination on firmness of strawberries stored at room temperature. Fruits were treated without or with gas with each gas at 40 ppm. N=12, Differences between control and treated groups (P<0.05-P<0.005). Difference between the Hydrogen+Hydrogen Sulfide and Hydrogen+Hydrogen Sulfide+Helium group (P<0.05).

FIG. 22 shows a graph of the effect of Hydrogen, Hydrogen Sulfide, and Helium and their combination on change in surface color (L* value) of strawberries stored at room temperature. Fruits were treated without or with gas with each gas at 40 ppm. N=12, Differences between control and treated groups (P<0.05-P<0.005). Difference between the Hydrogen+Hydrogen Sulfide and Hydrogen+Hydrogen Sulfide+Helium group (P<0.05).

FIG. 23 shows a table that illustrates the prevention of growth of bacterial and fungal colonies by NaHS, Hydrogen Sulfide water (0.04%), without or with Hydrogen, and Helium gas during storage at room temperature. Bacteria and yeasts isolated from spoiled fruits (almond, strawberry, raspberry, blackberry, banana) were used as a source of mixed bacteria. Data shown in FIG. 23 are from bacteria and yeasts that were isolated from spoiled strawberries. For each condition, six agar plates were inoculated (equal volume) by bacteria or yeast from one colony isolated from spoiled strawberries and mixed in 1 ml of 0.1 M PBS pH 7.4. 20 microliters of the solution was used for streaking the plates. Cultures were treated without or with Hydrogen Sulfide, Hydrogen and Helium. Hydrogen Sulfide was generated by using NaHS (100 micrograms) or by using water saturated with Hydrogen Sulfide (0.04%, 5 ml). Foods and agar plates were stored within closed chambers where agar plates at room temperature. NaHS or H₂S saturated water was changed daily. The Hydrogen Sulfide was maintained at 40 ppm and was monitored by GasBadgePlus Gas monitor v3.0 placed within the closed chambers. Agar plates treated with Hydrogen or Helium were stored in a closed air-tight chambers which were first flushed with Hydrogen, Helium or first with Hydrogen and then Helium. Growth of bacterial and fungal colonies on agar plates was monitored daily and plates were scored on day 3 as follows. >75 colonies: ++++, 50-75: +++, 25-50: ++, <25: +No growth.

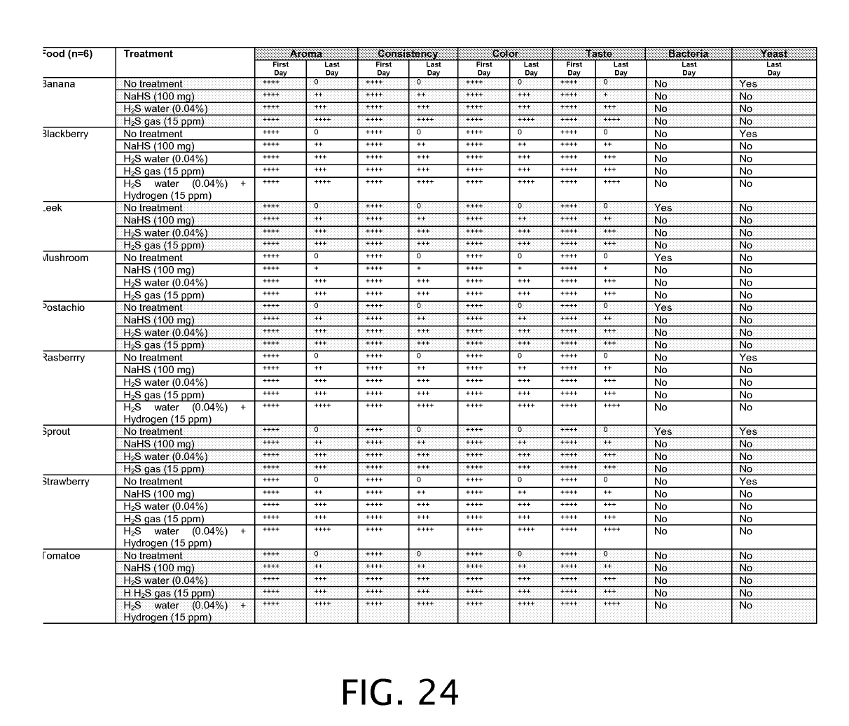

FIG. 24 shows a table of assessment of consistency, color and taste and growth of bacteria and yeast in food stored at room temperature within air-tight chambers. Treatment was with 100 mg NaHS placed within the chamber without water, five ml of Hydrogen Sulfide saturated water (0.04%) placed in the chamber, Hydrogen Sulfide gas (15 ppm) introduced to the chamber or mixture of five ml of Hydrogen Sulfide saturated (0.04%) water and Hydrogen gas (15 ppm) introduced into the chamber. In this table the consistency, color and taste were assessed semiquantitatively as follows on the first and last day of the experiment; Original: ++++, Small change; +++, Moderate change++. Severe change; +, Loss; 0. Growth of bacteria and yeast was checked by streaking agar plates. Yes: Growth confirmed, No: No growth seen. The duration of experiment varied depending on the food category.

Fresh fruits and vegetables are prone to fungal contamination in the field, during harvest, transport, and marketing, and by the consumer. It is also estimated that about 20% of all fruits and vegetables produced is lost each year due to spoilage. Many fruits and vegetables offer nearly ideal conditions for the survival and growth of many types of micro-organisms. Most micro-organisms that are initially observed on whole fruit or vegetable surfaces are soil inhabitants, members of a very large and diverse community of microbes that collectively are responsible for maintaining a dynamic ecological balance within most agricultural systems. Some molds can grow and produce mycotoxins on these commodities while certain yeasts and molds can cause infections or allergies.

We tested Hydrogen Sulfide in various ways to determine its impact on preservation of food and prevention of growth of germs. Decay, softening, and discoloration are common changes that accompany ripening and senescence of strawberry fruit. By analyzing parameters such as rotting index, firmness, and external color, it was found that when strawberry fruit was exposed to the Hydrogen Sulfide, senescence was delayed and post-harvest shelf life was prolonged.

Food to be protected was placed within a closed environment where Hydrogen Sulfide gas was introduced by several different means. To do this, we generated Hydrogen Sulfide gas by using NaHS that emits it when absorbs water from its environment or mixed with water as shown in FIGS. 10, and 14A, 14B-15, 18, 20, and 24-25 and used it as a gas as shown in FIGS. 11, 21, 22 and 24, or used it as water saturated with Hydrogen Sulfide (0.04%) that emits Hydrogen Sulfide as shown in FIG. 12 and FIG. 24. We also tested the impact of rinsing fruit or vegetables with water saturated with Hydrogen Sulfide or immersed them directly within such water as shown in FIG. 13. We used a variety of fruits that easily spoil (Strawberry, Raspberry, Blackberry, Banana, Fig, Cantaloupe, Pistachio, Kiwi, Pears and Peaches), vegetables (Sprout, Leek, Mushroom, Avocado, Broccoli, Lettuce, Lotus roots, Yams, Potatoes and Sweet Potatoes), as well as Red Meat, Salmon, and Chicken. The experiments were carried out at either at 20° C. or at room temperature (˜25° C.) on a minimum of 6-12 items in each group and repeated at least four times to insure their reproducibility. Representative samples are shown when bacterial and/or yeast growth was easily visible grossly. However, each experiment were carried out generally for 7-12 days. The growth of bacteria and yeast was checked by streaking agar plates that were kept at room temperature and 37° C. as shown in FIGS. 9, 11 and the tables in FIGS. 23 and 24. At termination of each experiment, the consistency, color and taste of fruits and vegetables were assessed semi-quantitatively as shown in the table in FIG. 24 or quantitatively as shown in FIGS. 14A, 14B, 15-18, 21-22 and 25. Hydrogen Sulfide delays ripening and in all cases, the Hydrogen Sulfide treatment protected the foods from growth of bacteria and/or yeast and preserved the consistency, color and taste of food and vegetables. Treatment of Red Meat, Salmon and Chicken also prevented development of decay, foul smell, bacterial/yeast growth and the growth of larvae and flies as shown in FIG. 10. Together, these findings show that Hydrogen Sulfide provides a broad protection of foods.

Thus, Hydrogen Sulfide can be used for prevention of growth of yeast that commonly contaminate fruits including Botrytis cinerea, Rhizopus (in strawberries), Alternaria, Penicillium, Cladosporium and Fusarium followed by Trichoderma and Aureobasidium. Hydrogen Sulfide can be used for prevention of growth of most common yeast that spoil grapes and for inhibiting growth of Alternaria and B. cinerea and Cladosporium as well as Iternaria, Cladosporium, Penicillium, Fusarium and Less common Trichoderma, Geotrichum and Rhizopus that are commonly found in citrus fruits. Hydrogen Sulfide can also be used for common bacterial pathogens for fruits such as Pseudomonas, Erwinia, Xanthomonas, Acidovorax or fungal pathogens such as Penicillium, Geotrichum, Fusarium, Botrytis, Colletotrichum, Mucor, Monilinia, Rhizopus, and Phtyophthora. Hydrogen Sulfide can be used for prevention of growth of vegetable bacteria including Geotrichum, Rhizopus, Phytophthora, Fusarium, Pythium, Alternaria, Colletotrichum, Botrytis, Sclerotinia, Pseudomonas, Erwinia, Xanthomonas, Bacillus Clostridium, and Lactic acid bacteria as well as others including Aerobacter sp, Bacillus sp., Staphylococcus sp., Escherichia Sp., Cellulomonas sp., Proteus sp., sulfate producing bacteria and yeast such as Rhodotorula sp., Alternaria sp., Aspergillus sp., Penicillioum sp., Trichoderma sp., and Rhizotonia sp. that are commonly found on soils, fruits, and vegetables.

Hydrogen Sulfide can also be used to decontaminate infected or infested environments and can be used for disinfection of cosmetics, leather, electrical insulation, textiles, plant seeds, fur, wood and soil and numerous other materials that support undesirable growth of micro-organisms. Besides for its food-preserving utility, Hydrogen Sulfide is useful for the disinfection of patches, catheters, tubes or any other materials used in medical facilities, agriculture, and biotechnical corporations. Hydrogen Sulfide can be used to prevent rot in seeds or crops and inhibit the spread of disease in fields. Hydrogen Sulfide can be used for treatment of infections including acne, which, when applied, kills the germs that cause pimples and rejuvenates the skin. Hydrogen Sulfide may be used to disinfect water or other contaminated liquids.

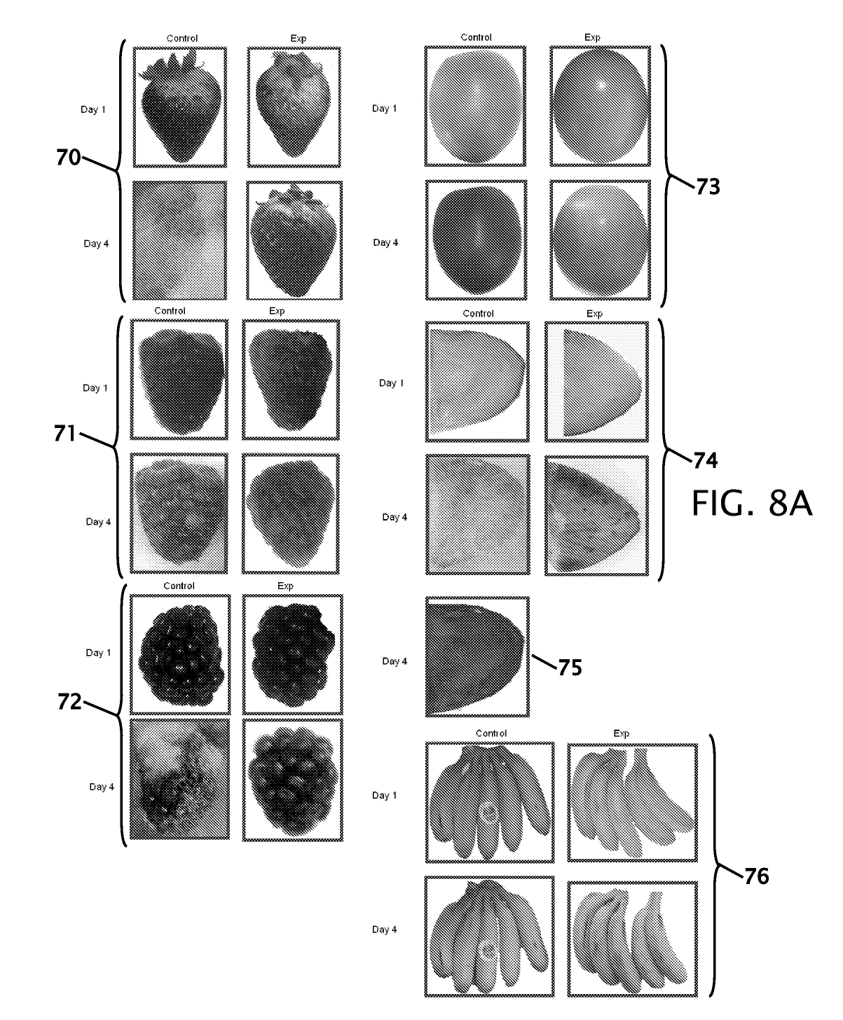

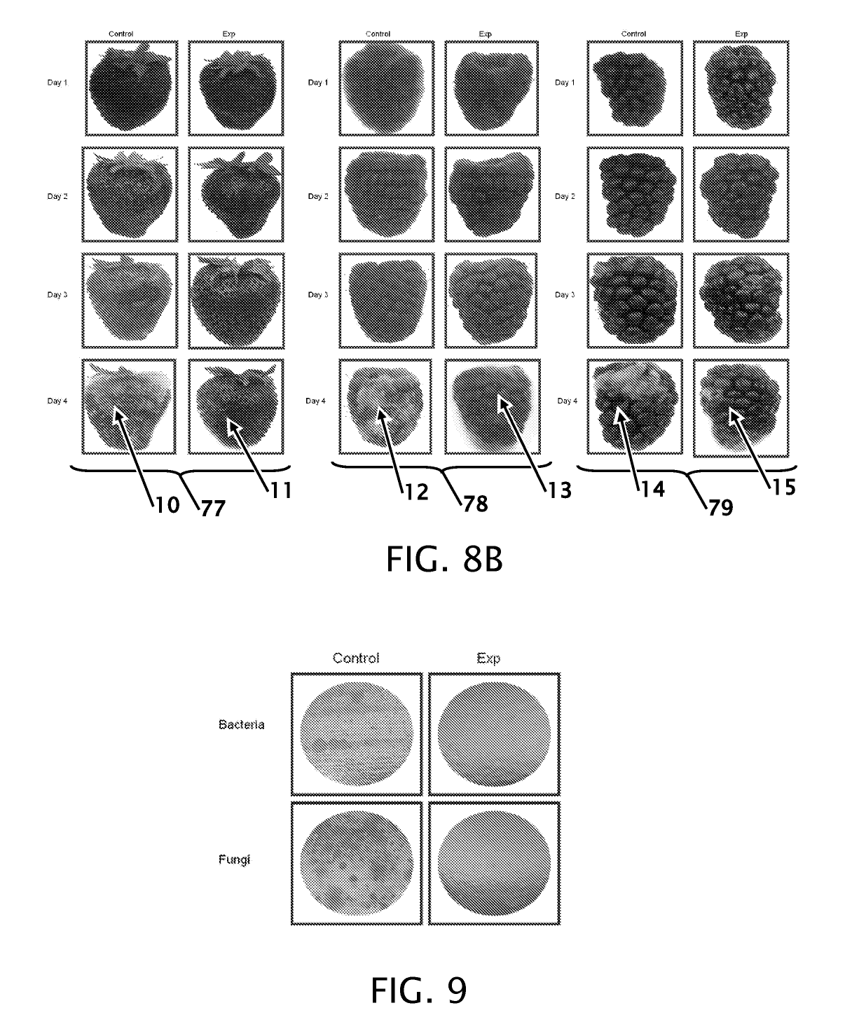

FIG. 7 shows the chemical structure of Sul-free. Hydrogen Sulfide can be used for disinfection of water particularly in places where equipment for filtering, heating or other treatment methods of water is not readily available or in the fields such as the battle field, under-developed countries or in sites where water is contaminated and cannot be consumed by humans. If the removal of Hydrogen Sulfide is required, it can be removed by aeration, heat or by presently available techniques that remove Hydrogen sulfide. One such product is Sul-Free™, a new group of organo-imino compounds that offer significant advantages for removal of Hydrogen sulfide. Sul-Free™ chemistry specifically targets Hydrogen sulfide, organo-sulfur compounds, and mercaptans. This unique new chemistry is synergistic with waste water systems, bacteria, and enzymes. In field waste water applications, Sul-Free™ WS 1500 quickly and specifically binds up sulfur. This includes stripping sulfur from the poisoned aerobic bacteria and enzymes that are beneficial and that have been deactivated by the sulfur bond. This reaction has shown the benefit of a natural increase of O₂ that, in turn, optimizes the bio-chemical balance of the system. Sul-Free™ does its job and frees the bacteria to do theirs. Its pleasant, safe aroma eliminates foul odors while it reacts with the Hydrogen Sulfide and mercaptans. Thus, a simple two step process of first adding Hydrogen Sulfide to the contaminated water followed by its removal, can provide drinking water.

Moreover, most if not all of food preservatives are added to the food without knowing the long term impact of the preservatives on human health. All food preservatives are compounds that do not exist in biological systems and for this reason, they can have adverse effects on such systems. Contrary to all previous attempts for use of preservatives, we attempted to primarily provide for conditions to preserve food by changing only the environment where food is stored. Introduction of Hydrogen Sulfide and Hydrogen to food environment, does not change food characteristics, and should have no adverse health effect, because it does not increase the level of Hydrogen Sulfide in the food. However, if added to the food, based on new emerging science, it should be beneficial to the consumer because of many health promoting effect of this gas. Hydrogen sulfide, is antioxidant, analgesic, reduces inflammation and promotes repair, increases ATP generation, increases membrane potential of mitochondria and prevents cell death and protects a variety of cells from undergoing apoptosis, is mitogenic and induces angiogenesis. On the other hand, the addition of Hydrogen to food does not alter any of the food attributes and is not expected to cause any health issue. Hydrogen is the lightest element in the periodic table and any Hydrogen that might be trapped within the food is expected to be lost upon opening the package that include it. Moreover, any residue that might remain, is expected to have beneficial effects including anti-oxidant activity.

Prevention of Crop Loss

Every dollar ($1) that is spent on pesticides yields four dollars ($4) in the amount of crops that are saved. Use of pesticides helps farmers, consumers and general public. Farmers benefit from increased crop yield by being able to grow a variety of crops throughout the year. Consumers of agricultural products benefit from being able to afford the vast quantities of produce throughout the year. The general public also benefits from the use of pesticides for the control of insect-borne diseases and illnesses. Avoiding crop loss without the health problems posed by pesticides can be achieved meeting certain specific requirements that a chemical must bear to be safe for the consumer. Pesticide should be a chemical that is naturally used by the crop itself to protect it against damage and pest. Pesticide can be used that leaves no trace or residue in the food and even if its level is increased in the food, it carries beneficial health effects. The present invention offers Hydrogen Sulfide as a single chemical that carries all these attributes. First, it can be used in a closed space for the growth of crop and to protect the crop by its insecticidal, fungicidal, rodenticidal, pediculicidal, and biocidal actions. In such a case, the crop is protected and yet, the crop when cut and shipped, will not carry any residue of the gas. Alternatively, the endogenous level of the Hydrogen Sulfide can be increased by transgenic approaches so that it affords more protection to the crop. In such cases, the level can be controlled as such that it does not harm the consumer. Moreover, the levels can be achieved to take advantage of the beneficial effects of Hydrogen Sulfide without impacting the color, aroma, consistency, flavor or other characteristics of the food to be consumed. We find that Hydrogen Sulfide is a general inhibitor of living organisms; it prevents the growth of micro-organisms including bacteria, yeast, as well as larger organisms such as grasshopper, mollusks, fruit flies, bees, and other pests. FIG. 9 and the table in FIG. 23 show the germicidal activity of Hydrogen Sulfide without or with Hydrogen. Mollusks, bees, grasshopper, drosophila, butterflies, and flies die within seconds by introducing NaHS (500 mg), Hydrogen Sulfide gas (40 ppm) or Hydrogen Sulfide saturated water (0.04%, 1 ml) within a closed environment at room temperature where pests are kept. By virtue of having such inherent properties, Hydrogen Sulfide is uniquely suited to be used universally to prevent loss of crops either in the field or in closed environments.

Because both Hydrogen and Hydrogen Sulfide were effective individually in increasing the food shelf life, we tested the combination of both of these gases with and without Helium on food preservation as shown in FIGS. 19 to 22 and in the table in FIGS. 23 and 24. Effect of Helium was comparable with Hydrogen in respect to prevention of food spoilage and similar to Hydrogen, Helium retarded but did not prevent growth of micro-organisms. However, effect of Helium on ripening and oxidation was greater than Hydrogen. Given that Hydrogen, Helium and Hydrogen Sulfide could increase the food shelf life, we determined the impact of multiple gases on food shelf life. We find that the combination of Hydrogen Sulfide with Hydrogen with and without Helium increases the food shelf life significantly more (p<0.05-0.005) than the Hydrogen Sulfide alone with the combination of Hydrogen Sulfide with Hydrogen and Helium being the most effective as shown in FIGS. 21 and 22.

In summary, the method that we have developed prevents fruit and vegetable ripening, prevents food spoilage or decay, prolongs food shelf life, prevents growth of micro-organisms and can substitute current methods of food preservation including those that require addition of preservatives, or the use of pasteurization, sterilization, cooking, drying, radiation, high frequency freezing, ultrasounds, high pressure processing, pulsed electric fields, pulsed light treatment, or cooling. The method preserves the natural characteristics of the food or processed food, such as color, flavor, aroma and texture, requires low energy and can be used by commercial companies as well as by the end consumers. The process does not require special packaging or removal of air from package or changing the composition of food, and no special machinery or technical skill. Our innovative method can be applied to fruits, produce, plants, meat, poultry, fish, water or any other food product and is of low cost both to companies and to consumers and can decrease the food wastage, and consequently the food shortage and should inevitably lead to reduction of the price of the food. We expect and anticipate that this technique can substitute or augment, most if not all, other technologies and methods of food preservation that require preservatives, or special machinery, or skills and is likely to become acceptable to public due to its low cost and health benefits that it offers since current chemical preservatives are no longer required to keep food fresh.

The process that we have developed is organic, eco-friendly, safe, and harmless to the food and to the user and can be used from the post-harvest time, during transport, processing to distribution and sale of the food. The method is also inexpensive and highly reduces the cost of loss of revenue by companies due to food spoilage and decay across the globe. We anticipate that this method will become the gold standard in food industry and is likely to eradicate food shortage, and will reduce the cost of food for the consumer, and will reduce the loss of revenue by farmers, producers, distributors and all other food companies. We expect that products can be introduced to the market that make it possible for the consumers to generate sufficient Hydrogen Sulfide and Hydrogen with convenient and practical means that can afford them to increase the shelf life of food at room temperature or in refrigerator in their homes. Since there is as yet no method for simple production of Helium, the use of this gas would be feasible at this time only at the industrial level.

Thus, specific embodiments of the process of food preservation with Hydrogen Sulfide without or with Hydrogen and with or without Helium have been disclosed. It should be apparent, however, to those skilled in the art that many more modifications besides those described are possible without departing from the inventive concepts herein. The inventive subject matter, therefore, is not to be restricted except in the spirit of the appended claims.

1. A process by which Hydrogen Sulfide without or with Hydrogen and with or without Helium are provided in the environment where food is stored comprising:
Providing a Hydrogen Sulfide gas from a liquid saturated with Hydrogen Sulfide or in a frozen form;
introducing said Hydrogen Sulfide gas or a Hydrogen Sulfide donor;
providing Hydrogen from electrolysis, magnesium or magnesium hydride or any other means, and/or;
providing Helium as gas,
or by adding or increasing the endogenous synthesis of said Hydrogen Sulfide gas or said Hydrogen in a food leading to an increase of said Hydrogen Sulfide gas and/or said Hydrogen, and
wherein concentrations of said Hydrogen Sulfide gas, said Hydrogen gas or said Helium gas is 1-1000 ppm and concentrations of said Hydrogen Sulfide donor, Sodium Hydro-Sulfide solution ranges from 0.1 mmol/L to 50 mmol/L, and said Hydrogen Sulfide concentrations 10⁻¹³˜10⁻⁸ mol L.

2. (canceled)

3. The process for providing Hydrogen Sulfide in an environment according to claim 1 to decontaminate or to prevent growth of living organisms and to act as a biocide or pesticide to kill Mollusks or to be used as fungicide to prevent the growth of molds and mildew, a disinfectant to prevent the growth and spread of bacteria, an insecticide to control a wide variety of bugs and insects and as a pediculicide or rodenticide to control mice and rats.

4. The process for providing Hydrogen Sulfide without or with Hydrogen and without or with Helium in an environment according to claim 1 for sterilization of solutions including water or other water containing solutions, as well as products and equipment in industry and medicine such as disinfection of medical materials comprising patches, catheters and tubes and to reduce infections in hospitals, agriculture, biotechnology, or any other technology.

5. The process for providing Hydrogen Sulfide without or with Hydrogen and without or with Helium in an environment according to claim 1 for treatment of infections comprising acne to kill, germs that cause pimples.

6. The process for providing Hydrogen Sulfide without or with Hydrogen and without or with Helium in an environment according to claim 1 for rejuvenation or prevention of aging process.

7. The process for providing Hydrogen Sulfide without or with Hydrogen and without or with Helium in an environment according to claim 1 to prevent rot in seeds or crops, and prevent the spread of pests and disease in fields.

8. The process for providing Hydrogen Sulfide without or with Hydrogen and without or with Helium in an environment according to claim 1 to prevent degradation or deterioration of products that are particularly vulnerable to destructive action(s) of micro-organisms.

9. The process for providing Hydrogen Sulfide without or with Hydrogen and without or with Helium in an environment according to claim 1 to delay ripening of fruits and vegetables.

10. The process for providing Hydrogen Sulfide without or with Hydrogen and without or with Helium in an environment according to claim 1 to prevent change in at least one of taste, color, consistency, aroma or other qualities of the food.

11. The process for providing Hydrogen Sulfide without or with Hydrogen and without or with Helium in an environment according to claim 1 to prevent spoilage of food.

12. The process for providing Hydrogen Sulfide without or with Hydrogen and without or with Helium in an environment according to claim 1 to prevent and delay decay, rancidity and decomposition of food.

13. The process for providing Hydrogen Sulfide without or with Hydrogen and without or with Helium in an environment according to claim 1 by which the endogenous production of Hydrogen Sulfide-Hydrogen is increased to protect food against spoilage or to prolong shelf life of said food.

14. (canceled)

15. The process for providing Hydrogen Sulfide without or with Hydrogen and without or with Helium in an environment according to claim 1 by which the effect of oxygen is reduced in living organisms.

16. A process by which Hydrogen Sulfide is used with hydrogen or Helium in an environment:
providing a Hydrogen Sulfide gas from a liquid saturated with Hydrogen Sulfide or in a frozen form to an environment to provide at least one of a group comprising of preserving food, treatment of infection, prevent rot, prevention of aging, to act as a biocide, to act as an insecticide, and to act as a disinfectant;
wherein concentrations of said Hydrogen Sulfide gas, said Hydrogen gas or said Helium gas is 1-1000 ppm and concentrations of said Hydrogen Sulfide donor, Sodium Hydro-Sulfide solution ranges from 0.1 mmol/L to 50 mmol/L, and said Hydrogen Sulfide concentrations 10⁻¹³˜10⁻⁸ mol L;
removing said Hydrogen Sulfide gas from said environment to eliminate an odor of Hydrogen Sulfide gas from said environment, and
providing Helium or Hydrogen into said environment.
